(19) United States
(12) Patent Application Publication
(10) Pub. No.: US 2020/0036887 A1
(43) Pub. Date: Jan. 30, 2020

(54) IMAGE PICKUP APPARATUS CORRECTING IN-FOCUS POSITION DETECTED BY AUTO-FOCUSING MECHANISM, FOCUS DETECTION METHOD, AND STORAGE MEDIUM STORING FOCUS DETECTION PROGRAM

(71) Applicant: CANON KABUSHIKI KAISHA, Tokyo (JP)

(72) Inventors: Hirohito Kai, Tokyo (JP); Takuya Izumi, Yokohama-shi (JP); Hideaki Yamamoto, Kawasaki-shi (JP)

(21) Appl. No.: 16/518,296

(22) Filed: Jul. 22, 2019

(30) Foreign Application Priority Data
Jul. 24, 2018 (JP) 2018-138630

(51) Int. Cl. H04N 5/232; H04N 5/357

(52) U.S. Cl. CPC H04N 5/23212; H04N 2101/00; H04N 5/357; H04N 5/23264

(57) ABSTRACT

An image pickup apparatus that is capable of correcting an in-focus position even if a state of an optical system changes. A focus detecting unit receives an incident light beam from an object. The focus detecting unit includes a focus detecting sensor that converts a light amount distribution of an object image into an electrical signal, an image forming lens that makes the incident light beam form object images on the sensor, a field mask arranged at the object side of the lens and having an opening for defining an image field of the object images, a storage unit that stores an initial value about the opening that is comparable with the output signal, and a correction unit that sets a correction value for detecting a focusing state to an object based on a value about the opening calculated from the output signal and the initial value.

### BACKGROUND OF THE INVENTION

### Field of the Invention

The present invention relates to an image pickup apparatus, a focus detection method, and a storage medium storing a focus detection program, and in particular, relates to a technique for correcting an in-focus position detected by an automatic focusing mechanism.

### Description of the Related Art

Focus adjustment for automatic focusing has been applied to an image pickup apparatus, such as a single-lens reflex camera that exchanges photographing lenses. The focus adjustment is a process for detecting a component individual difference resulting from component tolerance etc. and storing an adjustment value for the automatic focusing corresponding to an operating characteristic of each component into a nonvolatile memory beforehand set at a time of factory shipment. Thereby, the image pickup apparatus is capable of performing accurate automatic focusing during actual photographing by using the adjustment value stored.

However, the optical path length of a focus detection optical system may change as a result of wear of a component by long-term use of the image pickup apparatus, and positional displacement of an optical component or characteristic fluctuation of a component due to use under a particular environment, such as a high-temperature environment and a low-temperature environment. In that case, the automatic focusing using the focus adjustment value set at the time of factory shipment may lower focusing accuracy.

Accordingly, there is a known technique that calculates a correction value at a predetermined timing for correcting the focus adjustment value that is stored in the nonvolatile memory at the time of factory shipment. This maintains high accuracy of the automatic focusing function. For example, Japanese Laid-Open Patent Publication (Kokai) No. 2002-98884 (JP 2002-98884A) discloses a technique that calculates position displacement of a sub mirror, which reflects an incident light beam toward a focus detecting device, by forming patterns on the sub mirror in areas corresponding to effective areas of a focus detecting sensor and by measuring the patterns with the focus detecting sensor.

However, since the stop position of the sub mirror may change for every distance measurement, when the position of the sub mirror is detected by the technique described in the above-mentioned publication, the correction value calculated for the optical system of the focus detecting device may change. As a result, there is a possibility that high focusing accuracy cannot be obtained.

### SUMMARY OF THE INVENTION

The present invention provides an image pickup apparatus that is capable of correcting an in-focus position appropriately even if a state of an optical system in a focus detecting device changes.

Accordingly, a first aspect of the present invention provides an image pickup apparatus including an optical element that guides an incident light beam from an object, and a focus detecting unit configured to receive the incident light beam guided by the optical element. The focus detecting unit includes a focus detecting sensor that converts a light amount distribution of an object image into an electrical signal, an image forming lens that makes the incident light beam form object images on the focus detecting sensor, a field mask that is arranged between the optical element and the image forming lens and that has an opening for defining an image field of the object images formed on the focus detecting sensor, a storage unit configured to store an initial value about the opening of the field mask that is comparable with the output signal from the focus detecting sensor, and a correction unit configured to set up a correction value for detecting a focusing state to an object based on a value about the opening of the field mask calculated from the output signal of the focus detecting sensor at a predetermined timing and the initial value.

Accordingly, a second aspect of the present invention provides an image pickup apparatus including an optical element that guides an incident light beam from an object, and a focus detecting unit configured to receive the incident light beam guided by the optical element. The focus detecting unit includes a focus detecting sensor that converts a light amount distribution of an object image into an electrical signal, an image forming lens that makes the incident light beam form object images on the focus detecting sensor, a field mask that is arranged between the optical element and the image forming lens and that has openings for defining image fields of the object images formed on the focus detecting sensor, a storage unit configured to store initial values indicating positions of edge images of the openings provided in the field mask that are comparable with the output signal from the focus detecting sensor, a detection unit configured to detect position changes of the edge images of the openings of the field mask, which are found from the output signal of the focus detecting sensor at a predetermined timing, from the initial values, and a correction unit configured to switch a method of setting a correction value for detecting a focusing state to an object according to the relative position changes of the edge images that the detection unit detected.

Accordingly, a third aspect of the present invention provides a focus detection method for an image pickup apparatus, the focus detection method including a step of making a light beam that enters through an opening provided in a field mask that defines an image field form object images on a focus detecting sensor, a step of detecting light amount distributions of the object images as electrical signals by the focus detecting sensor, a step of calculating a value about an image of the opening of the field mask from the electrical signals, a step of setting a correction value for detecting an in-focus position to an object by comparing the calculated value with an initial value that is beforehand found as a value about the opening of the field mask, and a step of correcting the in-focus position to the object using the correction value during photographing.

Accordingly, a fourth aspect of the present invention provides a focus detection method for an image pickup apparatus, the focus detection method including a step of making light beams that enter through openings provided in a field mask that defines an image field form object images on a focus detecting sensor, a step of detecting a light amount distribution of each of the object images as an electrical signal by the focus detecting sensor, a step of calculating a position of an edge image of each of the openings of the field mask from the electrical signal; a step of setting a correction value for detecting an in-focus position to an object by comparing the calculated position with an initial value that is beforehand found as a value about a position of an edge image of each of the openings of the field mask, and a step of correcting the in-focus position to the object using the correction value during photographing. The correction value for correcting the in-focus position is set to double of an amount of position change of the edge image from the initial value in the step of setting the correction value in a case where the relative position changes of the edge images are approximately equal to each other. The correction value for correcting the in-focus position is set to a gravity-center moving amount in a correlation orthogonal direction of the light amount obtained from the focus detecting sensor in the step of setting the correction value in a case where the relative position changes of the edge images are approximately linear.

Accordingly, a fifth aspect of the present invention provides a non-transitory computer-readable storage medium storing a control program causing a computer to execute the control method of the third aspect.

Accordingly, a sixth aspect of the present invention provides a non-transitory computer-readable storage medium storing a control program causing a computer to execute the control method of the fourth aspect.

According to the present invention, since an in-focus position is corrected appropriately in response to change in state of the optical system in the focus detecting device, high focusing accuracy is maintained.

Further features of the present invention will become apparent from the following description of exemplary embodiments with reference to the attached drawings.

### BRIEF DESCRIPTION OF THE DRAWINGS

FIG. 1 is a sectional view showing a schematic configuration of an image forming apparatus according to embodiments of the present invention.

FIG. 2 is a view for describing a schematic configuration of a focus detecting device in a first embodiment.

FIG. 3A, FIG. 3B, and FIG. 3C are views for describing relations between an object and an object image formed on a focus detecting sensor in the first embodiment.

FIG. 4A and FIG. 4B are views for describing deviation of an image formation position resulting from change in state of a focus detection optical system in the first embodiment.

FIG. 5 is a flowchart showing a focus-adjustment-value correction process in the first embodiment.

FIG. 6 is a flowchart showing a focus-adjustment-value correction process in a second embodiment.

FIG. 7 is a view for describing a schematic configuration of a focus detecting device in a third embodiment.

FIG. 8 is a view for describing a relation between an image-pickup area and an object image formed on a focus detecting sensor in the third embodiment.

FIG. 9A and FIG. 9B are views for describing deviation of an image forming position resulting from first change in state of the focus detection optical system in the third embodiment.

FIG. 10A and FIG. 10B are views for describing deviation of an image forming position resulting from second change in state of the focus detection optical system in the third embodiment.

FIG. 11 is a flowchart showing of a process for switching correcting contents used at a time of detecting a focusing state in the third embodiment.

FIG. 12A and FIG. 12B are plan views showing a field mask and a multi-hole aperture stop in a fourth embodiment.

FIG. 13A and FIG. 13B are plan views showing a secondary image forming lens and a focus detecting sensor in the fourth embodiment.

FIG. 14 is a view for describing object images formed on the focus detecting sensor in the fourth embodiment.

FIG. 15A and FIG. 15B are views showing output waveforms from the focus detecting sensor when the state of the focus detection optical system in the fourth embodiment is changed.

FIG. 16A and FIG. 16B are views showing output waveform in an accumulation period which is different from the focus detecting sensor in a fourth embodiment.

FIG. 17A and FIG. 17B are views showing examples of output waveforms from the focus detecting sensor in the fourth embodiment under a photographing condition that is unsuitable for detecting of an inter-image distance.

FIG. 18 is a flowchart showing a process for selecting an edge image used for calculating a correction value in the fourth embodiment.

FIG. 19A through FIG. 19D are views showing examples of output waveforms from respective reading areas in the fourth embodiment.

### DESCRIPTION OF THE EMBODIMENTS

Hereafter, embodiments according to the present invention will be described in detail by referring to the drawings.

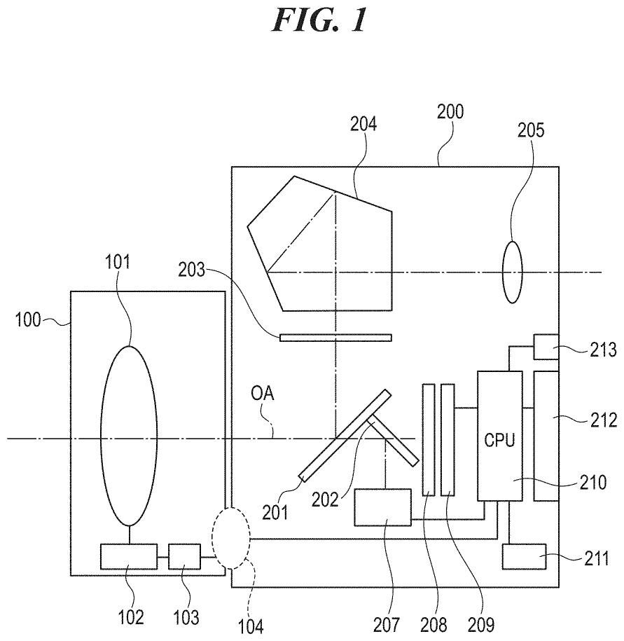

FIG. 1 is a sectional view showing a schematic configuration of an image forming apparatus according to embodiments of the present invention. The image pickup apparatus schematically consists of an image pickup apparatus body 200 and a photographing lens 100 that is detachably attached to an unillustrated lens mount (a lens mounting mechanism) provided in the image pickup apparatus body 200.

The image pickup apparatus body 200 is provided with an electric contact unit 104, a mirror unit including a main mirror 201 and a sub mirror 202, a focusing screen 203, a pentagonal roof prism 204, an eyepiece lens 205, a focus detecting device 207, and a focal-plane shutter 208. Moreover, the image pickup apparatus body 200 is provided with an image sensor 209, a camera CPU 210, a storage unit 211, a display device 212, an operation detection unit 213, and a sound production unit 214. The photographing lens 100 is provided with a focusing lens 101, a lens driving mechanism 102, and a lens control circuit 103.

An electric contact unit 104 (at the side of the image pickup apparatus body 200) is provided in the lens mount of the image pickup apparatus body 200. Similarly, an electric contact unit 104 (at the side of the photographing lens 100) is provided in a mount of the photographing lens 100. When the photographing lens 100 is attached to the lens mount, the camera CPU 210 and the lens control circuit 103 communicate through the electric contact units 104. The lens control circuit 103 has a memory (not shown) that stores performance information, such as focal length and a full aperture value, about the photographing lens 100, individual identification information (lens ID etc.) about the photographing lens 100, and information received from the camera CPU 210. The performance information and lens ID that the lens control circuit 103 holds are sent to the camera CPU 210 during an initial communication at a time of attachment to the image pickup apparatus body 200, and are stored into the storage unit 211.

The lens driving mechanism 102 drives the focusing lens 101 in an optical axis direction (a direction parallel to an optical axis OA). The lens control circuit 103 controls the lens driving mechanism 102 according to a signal (an instruction) from the camera CPU 210 to drive the focusing lens 101 in the optical axis direction so as to focus on an object. The lens driving mechanism 102 has an actuator as a driving source. A type of the actuator depends on a type of the photographing lens. For example, a stepping motor, a vibration actuator (ultrasonic motor), etc. are available. Although only the focusing lens 101 is shown in the photographing lens 100 in FIG. 1, other lenses, such as a variable power lens and a fixed lens, are provided in the photographing lens 100 actually.

An incident light beam (light from an object) is guided to the mirror unit provided in the image pickup apparatus body 200 through the focusing lens 101 in the photographing lens 100. The mirror unit is what is called a quick return mirror unit. The main mirror 201 is an optical element of which the center is formed as a half mirror area. The main mirror 201 is obliquely arranged in a photographing light path at a predetermined angle with respect to the optical axis. When the main mirror 201 is in the position (inside of the photographing light path) shown in FIG. 1, a part of the incident light beam transmits the half mirror area and is guided to the sub mirror 202. The sub mirror 202 is an optical element arranged at the back side (at the side of the image sensor 209) of the main mirror 201. The part of the incident light beam that transmits the main mirror 201 is reflected by the sub mirror 202 and is guided to the focus detecting device 207. It should be noted that the details of the focus detecting device 207 will be mentioned later.

When the main mirror 201 is in the position (inside of the photographing light path) shown in FIG. 1, a part of the incident light beam is reflected by the main mirror 201 and is guided to a finder optical system arranged above the main mirror 201. The incident light beam reflected by the main mirror 201 forms an image on the focusing screen 203 disposed at a position that is optically conjugate with the image sensor 209. The light (an object image) that has been diffused by and transmitted through the focusing screen 203 is converted into an erect image by the pentagonal roof prism 204. The erect image is enlarged by the eyepiece lens 205. A user is able to observe the erect image through a finder window (not shown).

It should be noted that the main mirror 201 and sub mirror 202 rotate clockwise in FIG. 1 toward the focusing screen 203 and retreat to the outside of the photographing light path at the time of exposure to the image sensor 209. In that state, the incident light beam passing through the photographing lens 100 reaches the focal-plane shutter 208. The focal-plane shutter 208 is a mechanical shutter that restricts the light amount incident on the image sensor 209. The light beam passing through the focal-plane shutter 208 forms an image on the image sensor 209. The image sensor 209 has a plurality of image sensing pixels that photoelectrically convert an object optical image into electrical signals. The electrical signals output from the image sensing pixels are converted into image data by a well-known technique. The image data is stored into a storage medium (not shown) like a memory card.

The camera CPU 210 integrally controls the entire image pickup apparatus by running a predetermined program stored in the storage unit 211 to control operations of sections constituting the image pickup apparatus. The storage unit 211 is constituted by a nonvolatile memory device, such as EEPROM, and stores various kinds of information needed for controlling the image pickup apparatus body 200. The various kinds of information include a program that the camera CPU 210 executes, parameters for operating the sections, and individual identification information (camera ID etc.) about the image pickup apparatus. Moreover, various parameter adjustment values about photographing etc. that have been adjusted using a standard lens (a photographing lens used at the time of adjustment in a factory of the image pickup apparatus) are stored in the storage unit 211.

The display device 212 is an LCD device, for example. An object image, a picked-up image, and a menu screen including items that a user sets for the image pickup apparatus, etc. are displayed on a display screen of the LCD device. When a user operates an operation member (not shown), the operation detection unit 213 detects the operation and sends a signal corresponding to the operation to the camera CPU 210. Operation members include various selection buttons, a dial, a release button that is a two-step switch consisting of a half press switch (SW1) and a full press switch (SW2) used for instructing photographing operations, and a touch panel laminated on the display device 212. The sound production unit 214 produces predetermined sound in response to an instruction by the camera CPU 210.

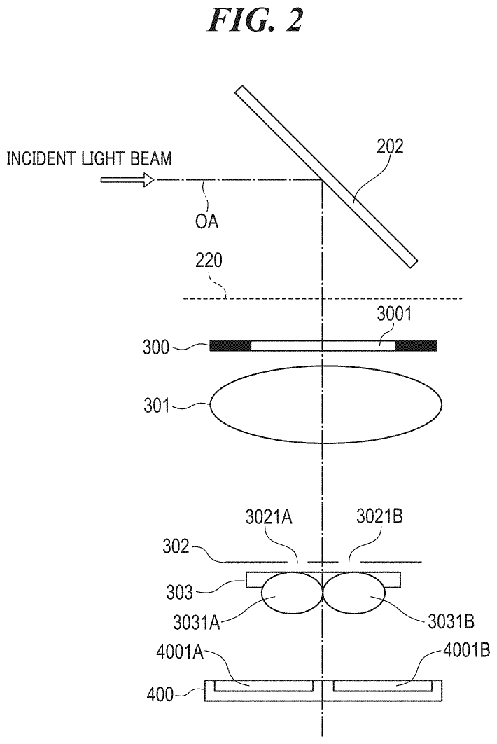

FIG. 2 is a view for describing a schematic configuration of the focus detecting device 207 in the first embodiment. The focus detecting device 207 generates light amount distributions about an object image from parts of an incident light beam passing through a plurality of predetermined areas and detects a focusing state of the photographing lens 100 by finding relative positional relationship between the light amount distributions generated.

The incident light beam reflected by the sub mirror 202 forms an image on a primary image plane 220 that is a predetermined image plane of the photographing lens 100 and is optically conjugate with the image sensor 209. The focus detecting device 207 is provided with a field mask 300, field lens 301, multi-hole aperture stop 302, secondary image forming lens 303, and focus detecting sensor 400 that are arranged in order from the primary image plane 220.

The field mask 300 is a sheet-like component and has a visual-field-mask opening 3001 that defines a view area of an image formed on the focus detecting sensor 400. Although the field mask 300 is arranged between the sub mirror 202 and the field lens 301 in the focus detecting device 207 of the illustrated example, it may be arranged between the sub mirror 202 and the primary image plane 220 or between the field lens 301 and the multi-hole aperture stop 302. However, since the focus detecting sensor 400 detects an image formed thereon by the secondary image forming lens 303 in the focus detecting device 207, it is desirable that the field mask 300 is arranged near the primary image plane 220.

The field lens 301 is a convex lens that has a function to form an image of the multi-hole aperture stop 302 in the vicinity of an exit pupil of the photographing lens 100. The multi-hole aperture stop 302 is a sheet-like component in which two multi-hole aperture openings 3021A and 3021B are formed. The multi-hole aperture openings 3021A and 3021B have functions to divide light of an object image that enters from the field lens 301. The secondary image forming lens 303 is a sheet-like component that forms object images on the focus detecting sensor 400 and is provided with a plurality of convex-lens shaped parts in the surface opposite to the focus detecting sensor 400. Hereinafter, those convex-lens shaped parts are referred to as secondary image forming convex lenses 3031A and 3031B. The secondary image forming convex lenses 3031A and 3031B are respectively arranged so as to correspond to the multi-hole aperture openings 3021A and 3021B. Each of the lenses 3031A and 3031B has a function to re-form the object image, which is formed on the primary image plane 220 by the photographing lens 100, on the focus detecting sensor 400.

The focus detecting sensor 400 is a line sensor that is configured to arrange a plurality of photoelectric conversion elements (pixels) in a line form and has a function to convert light amount distribution of the object image formed on the surface of the photoelectric conversion elements into electrical signals. A CCD sensor and a CMOS sensor are applicable to the focus detecting sensor 400, for example. The focus detecting sensor 400 is not limited to a line sensor, but may employ a two-dimensional sensor. In a case of using the two-dimensional sensor, signals of pixels within an area needed to detect an object image are extracted and used. In the following description, parts of the focus detecting sensor 400 in which photoelectric conversion elements (pixels) are arranged in a line form are referred to as focus detection sensor lines 4001A and 4001B.

The focus detection sensor lines 4001A and 4001B are arranged in the same direction as a direction (hereinafter referred to as a “correlative direction”) in which a light beam of an object image is divided by the multi-hole aperture openings 3021A and 3021B. Then, each of the focus detection sensor line 4001A and 4001B is arranged in an area that is wider than an image formation area of an object image of which an image field is defined by the visual-field-mask opening 3001 in the correlative direction in order to detect the image of the visual-field-mask opening 3001 formed on the focus detecting sensor 400. It should be noted that the optical path of the focus detecting device 207 may be folded by inserting a reflective mirror into the optical path for the purpose of miniaturization of the focus detecting device 207 and the image pickup apparatus body 200. Alternatively, the focus detecting device 207 may be configured to attain a function of each component by a combination of a plurality of components by inserting a lens component for the same purpose.

A light beam passing through the multi-hole aperture opening 3021A forms an image within the area of the focus detection sensor line 4001A by the secondary image forming convex lens 3031A. A light beam passing through the multi-hole aperture opening 3021B forms an image within the area of the focus detection sensor line 4001B by the secondary image forming convex lens 3031B. The focus detecting device 207 calculates a defocus value using the electrical signals that the focus detection sensor lines 4001A and 4001B detect with the focus detection method by well-known secondary image formation phase-difference detection.

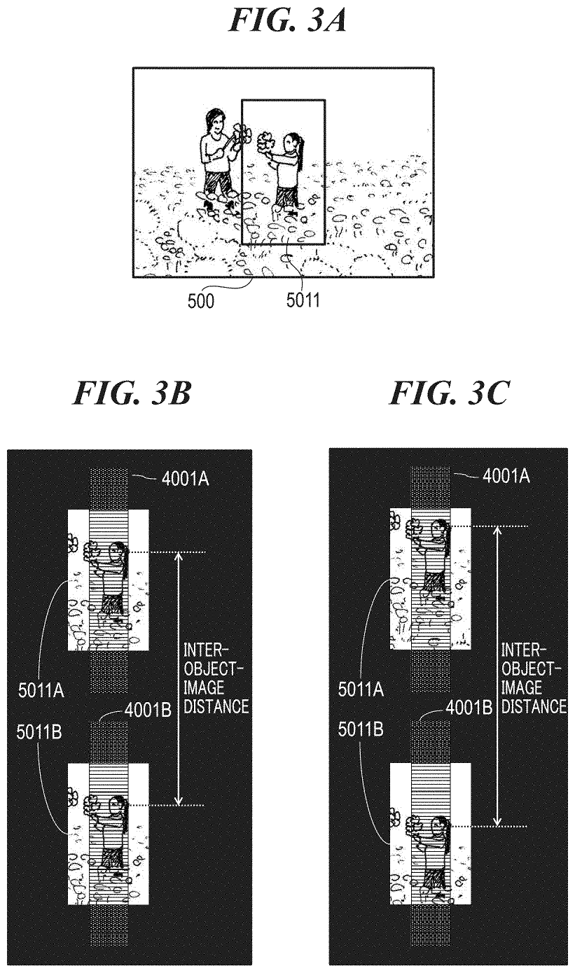

FIG. 3A, FIG. 3B, and FIG. 3C are views for describing relations between an object and an object image formed on the focus detecting sensor 400. FIG. 3A is a view for describing a relation between an image-pickup area 500 of the image pickup apparatus and a focus detection area 5011 arranged in the image-pickup area 500. The focus detection area 5011 is a target area of the focus detection in the image-pickup area 500 and is defined by the visual-field-mask opening 3001. An object image (optical image) in the focus detection area 5011 is formed on the focus detecting sensor 400.

FIG. 3B and FIG. 3C are views showing examples of the object images formed on the focus detecting sensor 400. The object image in the focus detection area 5011 defined by the visual-field-mask opening 3001 is projected as two images on image areas 5011A and 5011B by the multi-hole aperture opening 3021A and 3021B and the secondary image forming convex lens 3031A and 3031B.

A distance between the two object images projected on the focus detecting sensor 400 depends on a defocusing state of the object image. FIG. 3B shall show a state where a person who is a main object is in focus. In that case, FIG. 3C shows a state where a background behind the person as the main object is in focus because an inter-image distance of the person as the main object in FIG. 3C is wider than that in FIG. 3B.

The method of calculating a distance between object images (an inter-object-image distance) on the basis of outputs of the focus detection sensor lines 4001A and 4001B is well-known. Hereinafter, that operation method is referred to as “correlation operation”. Moreover, an in-focus state (a defocus amount is zero (0)) is referred to as a “reference state”. An initial value of the inter-object-image distance in the reference state is beforehand stored in the storage unit 211 at the factory of the image pickup apparatus.

There is a known method that calculates a defocus amount on the basis of a change amount of the inter-object-image distance by comparing the inter-object-image distance obtained by the correlation operation executed at a predetermined timing with the inter-object-image distance in the reference state stored in the storage unit 211 at that timing. Accordingly, the focusing operation (focusing) on the object is completed by driving the focusing lens 101 so that the obtained defocus amount will be zero.

Thus, the method of calculating the defocus amount from an inter-object-image distance is known. In the meantime, the projecting positions of the object image on the focus detecting sensor 400 may change due to change in the state of the focus detection optical system in the focus detecting device 207. The state of the focus detection optical system changes resulting from contraction, expansion, and change in refractive index of the secondary image forming lens 303 accompanying moisture absorption or temperature change, for example. Moreover, the projection positions of the object images on the focus detecting sensor 400 may change when positions of various components change due to change in state of adhesive that fixes the components.

Accordingly, this embodiment pays attention to projection positions of edge images of the visual-field-mask opening 3001 in order to distinguish deviation of the projecting positions of the object images resulting from the change of the focus detection optical system in the focus detecting device 207 from deviation of the image positions resulting from defocusing. Specifically, the visual-field-mask opening 3001 also has a function as an edge member for detecting the change in state of the focus detection optical system. Accordingly, the deviation of the projecting positions of the object images resulting from the change in state of the focus detection optical system is detected on the basis of the deviation of the projection positions of the edge images of the visual-field-mask opening 3001. The change amount of the inter-image distance corresponding to the change in state of the focus detection optical system is calculated and held as a correction value on the basis of the detected change amount of the projection positions of the edge images of the visual-field-mask opening 3001. Then, the inter-image distance in the reference state is corrected using the correction value. This enables highly accurate focus detection.

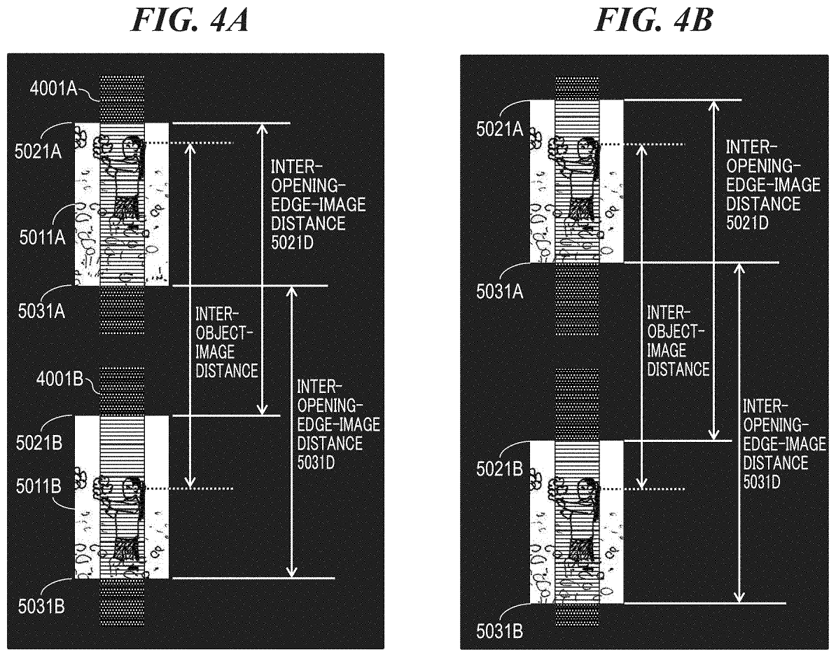

FIG. 4A and FIG. 4B are views for describing deviation of an image formation position resulting from change in state of the focus detection optical system. FIG. 4A is a view showing image formation states of the opening edges of the visual-field-mask opening 3001 and the object images onto the focus detecting sensor 400 at the time of focus adjustment (at the time of factory shipment). FIG. 4B is a view showing image formation states of the opening edges of the visual-field-mask opening 3001 and the object images onto the focus detecting sensor 400 when the state of the focus detection optical system changes from the state at the time of the focus adjustment. Hereinafter, the state of the focus detection optical system shown in FIG. 4A is referred to as a state “A”, and the state of the focus detection optical system shown in FIG. 4B is referred to as a state “B”. It should be noted that the focus detection sensor lines 4001A and 4001B have sufficient length for detecting images (opening edge images) of the edges of the visual-field-mask opening 3001 in the correlative direction.

An edge of the visual-field-mask opening 3001 is defined by the shape of the field mask 300 as a mechanical component and is unrelated to an object. Accordingly, the image of the edge is formed on the focus detecting sensor 400 in a predetermined shape in the correlative direction. Edge images 5021A and 5031A correspond to edges of one optical image formed on the focus detecting sensor 400 by the light beam passing through the visual-field-mask opening 3001. Edge images 5021B and 5031B correspond to edges of the other optical image formed on the focus detecting sensor 400 by the light beam passing through the visual-field-mask opening 3001. The edge images 5021A and 5021B correspond to edges of the images of the opening edge of the same part of the visual-field-mask opening 3001 that are divided by the multi-hole aperture stop 302. The edge images 5031A and 5031B correspond to edges of the images of the opening edge of the other same part of the visual-field-mask opening 3001 that are divided by the multi-hole aperture stop 302.

Since the field mask 300 is not a movable component that is driven by the image pickup apparatus body 200, the projection positions of the edge image of the visual-field-mask opening 3001 on the focus detecting sensor 400 does not change due to variations of stop positions of various components at the time of driving the image pickup apparatus. Accordingly, the edge images 5021A, 5021B, 5031A, and 5031B are stably detected and the correction value is stably calculated.

In the state “B” in FIG. 4B, an inter-opening-edge-image distance 5031D that is a distance between the edge images 5021A and 5021B and an inter-opening-edge-image distance 5021D that is a distance between the edge images 5031A and 5031B are larger than the distances in the state “A” in FIG. 4A by the same amount. That is, in the state “B”, the projection positions of the edge images of the visual-field-mask opening 3001 have varied due to the change in state of the focus detection optical system. The change amount of the projecting position of the edge image of the visual-field-mask opening 3001 is calculated by comparing the inter-opening-edge-image distance that has varied due to such change in state of the focus detection optical system with the inter-opening-edge-image distance in the reference state. And the correlation calculation result of the object image is corrected using the calculated change amount. Specifically, the correlation calculation result is corrected by adjusting the inter-object-image distance by the change of the current inter-opening-edge-image distance from the inter-opening-edge-image distance in the reference state. Thus, the defocus amount is calculated using the corrected inter-object-image distance.

There is the following method for calculating the changes of the inter-opening-edge-image distances 5021D and 5031D resulting from the change in state of the focus detection optical system. In the factory of the image pickup apparatus, the projection positions of the edge images of the visual-field-mask opening 3001 on the focus detecting sensor 400 are detected by the focus detection sensor lines 4001A an 4001B. As initial values about the visual-field-mask opening 3001, the inter-opening-edge-image distances at the time of focus adjustment, i.e., the inter-opening-edge-image distances 5021D and 5031D in the state “A” are stored into the storage unit 211. The light amount distributions about the edges of the visual-field-mask opening 3001 are found using the parts of the incident light beam passing through the plurality of predetermined areas. And the inter-opening-edge-image distances 5021D and 5031D are detectable by finding the relative positional relationship of the light amount distributions.

The change amount of the inter-opening-edge-image distance of the visual-field-mask opening 3001 resulting from the change of the focus detection optical system is calculated by comparing the inter-opening-edge-image distance in the reference state with the inter-opening-edge-image distance at the time of calculating the correction value. When the focus detection optical system is in the state “B” at the time of calculating the correction value, the inter-opening-edge-image distances at the time of calculating the correction value become equal to the inter-opening-edge-image distances 5021D and 5031D shown in FIG. 4B. That is, the change of the inter-opening-edge-image distance resulting from the change of the focus detection optical system is calculated by comparing the inter-opening-edge-image distance 5021D in the state “A” with that in the state “B” or by comparing the inter-opening-edge-image distance 5031D in the state “A” with that in the state “B”. This method has an advantage that the data volume is relatively small because the change is calculated in the same manner as the focus detection of an object image and the initial value is also stored in the storage unit 211 as the inter-opening-edge-image distance.

According to another method, an incident light beam is projected (an image is formed) to the focus detecting sensor 400 using a predetermined uniform luminance surface as an object beforehand in a factory. Then, an output signal (a light amount distribution waveform) of the focus detecting sensor 400 corresponding to the light amount distribution of an edge of the visual-field-mask opening 3001 is stored in the storage unit 211 as an initial value that is comparable with the output signal of the focus detecting sensor 400. The output signal of the focus detecting sensor 400 at this time shows the light amount distribution about the edge of the visual-field-mask opening 3001 formed by each of the light beams passing through the plurality of predetermined areas among the incident light beam. For example, the output signal of the focus detection sensor line 4001A near the edge image 5021A shown in FIG. 4A and the output signal of the focus detection sensor line 4001B near the edge image 5021B are stored in the storage unit 211. Alternatively, the output signal of the focus detection sensor line 4001A near the edge image 5031A and the output signal of the focus detection sensor line 4001B near the edge image 5031B may be stored.

Moreover, the change of the inter-opening-edge-image distance due to the change in state of the focus detection optical system is calculated by correlatively operating the output signal (waveform) stored in the storage unit 211 and the corresponding output signals of the focus detection sensor lines 4001A and 4001B. For example, when the focus detection optical system is in the state “B” at the time of calculating the correction value, the correlation operation between the states “A” and “B” is performed for each of the edge images 5021A, 5021B, 5031A, and 5031B. Since this method enables the calculation of the change of the inter-opening-edge-image distance by only either one of the focus detection sensor lines 4001A and 4001B, an object is hardly treated as unsuitable, and accordingly, there is an advantage to facilitate the correction. Moreover, even if opening images of the field mask 300 are crowded on the focus detecting sensor 400 because there are many focus detection areas 5011 and many openings of the multi-hole aperture stop 302, there is a merit that detects the change of the inter-image distance appropriately. Even if the optical path length changes due to change inside the focus detecting device 207 (focus detection optical system), a highly accurate focusing function is maintained by the above-mentioned methods.

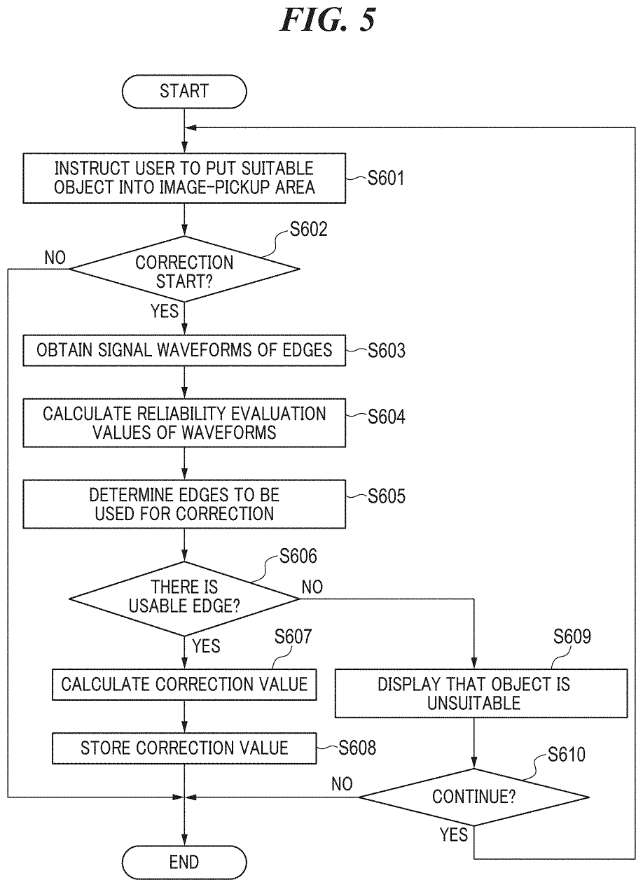

FIG. 5 is a flowchart for describing a focus adjustment value correction process in the focus detecting device 207. Each process (step) shown by S-number in FIG. 5 is achieved when the camera CPU 210 runs a predetermined program stored in the storage unit 211 so as to control actions of each section of the image pickup apparatus body 200. In the description, the focus adjustment value correction process shall be started when a user instructs execution of the focus adjustment value correction process to the camera CPU 210 by operating a predetermined operating member (for example, a menu screen) as a trigger. Moreover, an initial value about the visual-field-mask opening 3001 is beforehand stored in the storage unit 211. The initial value may be the inter-opening-edge-image distance at the time of the focus adjustment in the factory mentioned above, or may be light amount distribution waveforms (output signals of the focus detection sensor lines 4001A and 4001B) of the opening edge detected when a uniform luminance surface is used as an object.

In S601, the camera CPU 210 instructs a user to operate the image pickup apparatus so as to put a suitable object into the image-pickup area (field angle) by displaying a message on the display device 212. It should be noted that the suitable object means an object that hardly causes a detection error at the time when the waveform of the edge of the visual-field-mask opening 3001 is detected. For example, a uniform surface with a certain luminance is an ideal as the suitable object so that a suitable output will be obtained outside the focus detection area 5011 that is restricted so as not to enter an incident light beam and the inter-object-image distance will not be calculated during a process of the correlation operation of the edge images of the visual-field-mask opening 3001. At this time, the object may be observed in a state where the object image is not formed on the primary image plane 220 by detaching the photographing lens 100 in order not to calculate the inter-object-image distance.

In S602, the camera CPU 210 determines whether a received user's instruction is correction start or a correction stop. The user is able to instruct the correction start and the correction stop by an operation (for example, a button operation) of a predetermined operating member. When determining that the correction start instruction is received (YES in S602), the camera CPU 210 proceeds with the process to 5603, and when determining that the correction stop instruction is received (NO in S602), the camera CPU 210 finishes this process.

In S603, the camera CPU 210 obtains the signal waveforms of the edge images 5021A, 5021B, 5031A, and 5031B equivalent to the image forming positions of the edges of the visual-field-mask opening 3001. A signal waveform may be obtained by controlling accumulation period of the focus detecting sensor 400 so that the output signals become a steady value because the signals in a predetermined area in the focus detection area 5011 are saturated in order not to calculate the inter-object-image distance during the process of the correlation operation of the opening edge images. Moreover, the edges of which the signal waveforms are obtained may be changed according to the specification of the focus detecting device 207. For example, when the focus detecting device 207 is configured to perform the correlation operation not only in a vertical direction (up-and-down direction) as shown in FIG. 3B and FIG. 3C but also in a horizontal direction (left-and-right direction), edges in the horizontal direction may be detected in addition to edges in the vertical direction.

Moreover, when additional focus detection areas are arranged at right and left sides of the focus detection area 5011 that is arranged in the center area of the image-pickup area 500 as shown in FIG. 3A, for example, edges may be detected for every focus detection area. Such a configuration will be described later as a third embodiment.

In S604, the camera CPU 210 calculates a reliability evaluation value by evaluating the reliability of the signal waveforms by inspecting whether the waveform signals obtained in S603 are suitable for calculating a correction value. For example, when each of the following first, second, and third conditions is satisfied, various parameters are set so that the reliability evaluation value becomes high. The first condition is that the output is low outside the focus detection area 5011. The second condition is that the output is high inside the focus detection area 5011. The third condition is that the contrast in the focus detection area 5011 is low and that the correlation operation using opening edge images is available. It should be noted that these three conditions are examples and that other conditions may be used in place of them or may be added.

In S605, the camera CPU 210 decides at least one edge used for correction on the basis of the reliability evaluation value calculated in S604. In S605, the edge of which the reliability evaluation value is largest may be used or a plurality of edges of which the reliability evaluation values are more than a predetermined threshold may be used.

In S606, the camera CPU 210 determines whether there is any edge that is usable for the correction. When determining that one or more edges are usable for the correction (YES in S606), the camera CPU 210 proceeds with the process to S607, and when determining that no edge is usable for the correction (NO in S606), the camera CPU 210 proceeds with the process to S609.

In S607, the camera CPU 210 calculates a correction value. At that time, when a plurality of edges are determined to be usable for the correction in S606, an average calculated from the plurality of edges is used as the correction value. Alternatively, the correction value may be calculated on the basis of the edge of which the reliability evaluation value is largest or may be calculated by weighting according to the reliability evaluation value.

In S608, the camera CPU 210 stores the calculated correction value into the storage unit 211. S607 and S608 correspond to the process that sets up the correction value, which is used when detecting a focusing state, on the basis of the initial value and the output signal of the focus detecting sensor 400 at the timing of the focus adjustment value correction process. In actual photographing after that, the camera CPU 210 cancels change of a projection position of an object image due to change in state of the focus detection optical system using the correction value stored in the storage unit 211. Thereby, even if a deviation occurs in a focus position from the state at the time of factory shipment, the deviation is corrected appropriately and a highly accurate focusing is available.

In S609, which is the subsequent process when the determination result in S606 is NO, the camera CPU 210 notifies the user that the object is unsuitable by displaying a message on the display device 212. In S610, the camera CPU 210 determines whether the instruction to continue (re-execute) the focus adjustment value correction process is received. For example, the camera CPU 210 displays a screen for prompting a user to select continuation or completion of the focus adjustment value correction process on the display device 212. When determining that the continuation of the focus adjustment value correction process is instructed (YES in S610), the camera CPU 210 returns the process to S601. When determining that the completion of the focus adjustment value correction process is instructed, the camera CPU 210 finishes this process.

As described above, a deviation of a projection position of an object image due to change in state of the focus detection optical system is detected using a deviation of a projection position of an edge image of the visual-field-mask opening 3001 in the first embodiment. Then, a change amount of the inter-image distance due to the change in state of the focus detection optical system in the reference state is calculated and is saved as the correction value. During actual photographing, highly accurate focus detection is available by correcting an in-focus position with respect to an object using the correction value.

Next, a second embodiment of the present invention will be described. In the first embodiment, the focus adjustment value correction process is executed in response to a user's instruction, and the calculated correction value is stored in the storage unit 211. As compared with this, in the second embodiment, the focus adjustment value correction process is executed when the focus detecting device 207 detects a focusing state during photographing. That is, the focus adjustment value correction process is executed before executing the focusing as a regular camera operation (photographing operation), and the calculated correction value is stored to the storage unit 211 and is applied to the photographing. It should be noted that the second embodiment is different from the first embodiment only in the control by the camera CPU 210 and that the entire configuration of the image pickup apparatus in the second embodiment is the same as that in the first embodiment. Hereinafter, the description that is duplicated with the first embodiment is omitted and different points from the first embodiment will be mainly described.

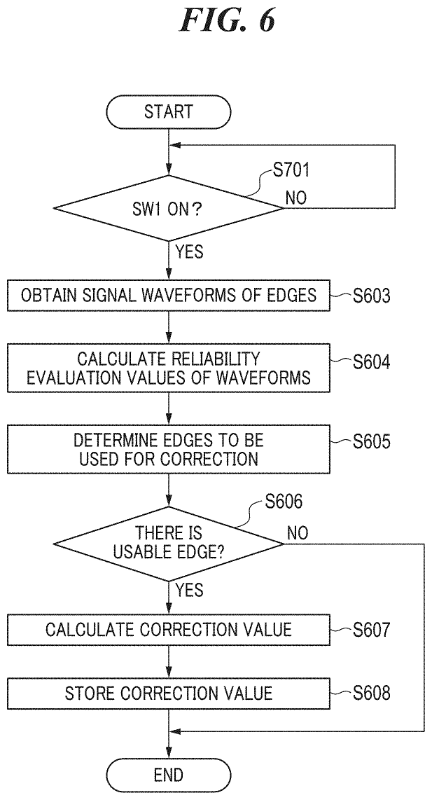

FIG. 6 is a flowchart showing a focus-adjustment-value correction process in the second embodiment. Each process (step) shown by S-number in FIG. 6 is achieved when the camera CPU 210 runs a predetermined program stored in the storage unit 211 so as to control actions of each section of the image pickup apparatus body 200. It should be noted that a process (step) in the flowchart in FIG. 6 that is the same as that in the flowchart in FIG. 5 is indicated by the same S-number and that a duplicated description is omitted. Moreover, the initial value about the visual-field-mask opening 3001 shall be beforehand stored in the storage unit 211 in the factory of the image pickup apparatus as with the first embodiment. For example, the initial value is an output signal (a light amount distribution waveform) of the focus detecting sensor 400 about the inter-edge-image distance of the visual-field-mask opening 3001 or the light amount distribution of the opening edge at the time of the focus adjustment according to the first embodiment.

In S701, the camera CPU 210 determines whether the half press switch (the SW1) turns ON by half-pressing the release button, which is one of the operating members. When determining that the half press switch turns ON (YES in S701), the camera CPU 210 proceeds with the process to S603. When determining that the half press switch keeps OFF (NO in S701), the process in S701 is repeated. That is, the camera CPU 210 waits until the half press switch turns ON, and starts the focus adjustment value correction process before starting the focusing operation for an object when the half press switch turns ON.

Since the processes in S603 through S608 are the same as that in S603 through S608 in FIG. 5, their descriptions are omitted. When determining that there is no usable edge (NO in S606), the camera CPU 210 finishes this process because shift to the operation for photographing an object is needed. The camera CPU 210 performs the regular focusing process after finishing the focus adjustment value correction process.

As mentioned above, in the second embodiment, the focus adjustment value is corrected at the timing of the focusing operation for the regular photographing. That is, the correction value is calculated and is stored before the focusing operation, which is one of regular photographing operations, and is applied to the focusing on an object during the actual photographing. Thereby, the user does not need to be conscious of the change in state of the focus detection optical system and is able to obtain the highly accurate focusing result to an object.

Next, a third embodiment of the present invention will be described. Although the focus detecting device in which one focus detection area is set in the image-pickup area is taken up in the first and second embodiments, a focus detecting device in which three focus detection areas are set in the image-pickup area is taken up in a third embodiment. Since the schematic structure of the image pickup apparatus according to the third embodiment is the same as the image pickup apparatus according to the first embodiment except for the configuration of the focus detecting device, the common description is omitted. In the following description, a component of the focus detecting device in the third embodiment that has a function equivalent to a component of the focus detecting device 207 shown in FIG. 2 is indicated by the same reference numeral and a duplicated description is omitted. Moreover, the camera CPU 210 controls the sections according to the configuration of the focus detecting device.

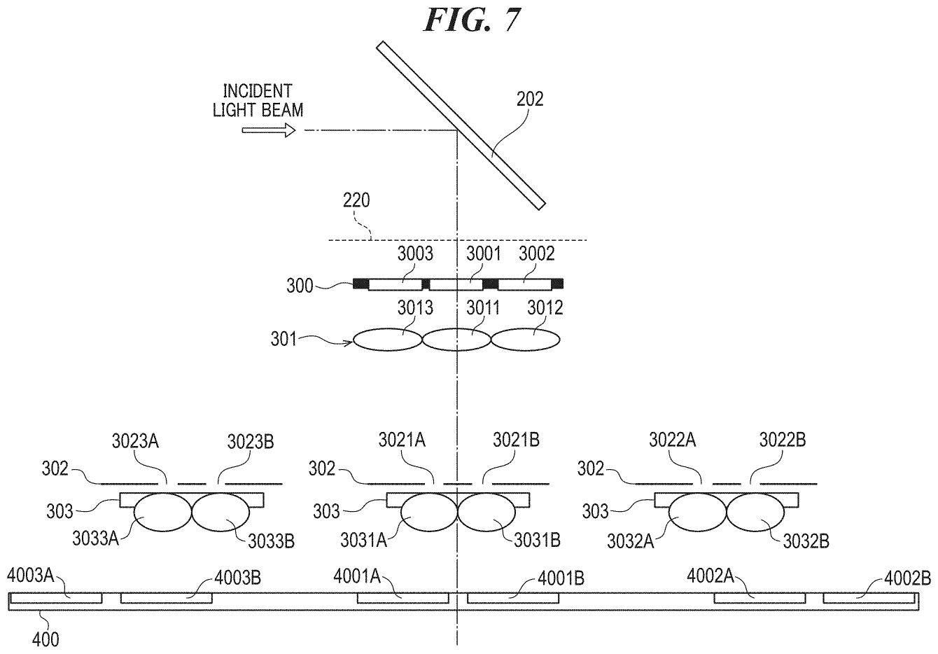

FIG. 7 is a view for describing a schematic configuration of the focus detecting device 207 in the third embodiment. The focus detecting device 207 is provided with a field mask 300, field lens 301, multi-hole aperture stop 302, secondary image forming lens 303, and focus detecting sensor 400 that are arranged in order from the primary image plane 220.

A plurality of visual-field-mask openings (three openings in this embodiment) 3001, 3002, and 3003 are formed in the field mask 300. The visual-field-mask openings 3001, 3002, and 3003 have the function to define the image fields imaged on the focus detecting sensor 400, respectively. The field lens 301 has three convex lenses 3011, 3012, and 3013 that respectively correspond to the visual-field-mask openings 3001, 3002, and 3003. Each of the convex lenses 3011, 3002, and 3013 has a function to form an image of the multi-hole aperture stop 302 in the vicinity of the exit pupil of the photographing lens 100.

The multi-hole aperture stop 302 is provided with three sets of openings including multi-hole aperture openings 3021A and 3021B, multi-hole aperture openings 3022A and 3022B, and multi-hole aperture openings 3023A and 3023B. The multi-hole aperture openings 3021A and 3021B have functions to divide a light beam of an object image that enters from the convex lens 3011. Similarly, the multi-hole aperture openings 3022A and 3022B have functions to divide a light beam of an object image that enters from the convex lens 3012, and the multi-hole aperture openings 3023A and 3023B have functions to divide a light beam of an object image that enters from the convex lens 3013.

The secondary image forming lens 303 is provided with a plurality of sets (three sets in this embodiment) of convex-lens shaped parts in the surface opposite to the focus detecting sensor 400. Each of the sets has two convex lenses. In the following description, the three sets of convex-lens shaped parts of the secondary image forming lens 303 shall be referred to as secondary image forming convex lenses 3031A and 3031B, secondary image forming convex lenses 3032A and 3032B, and secondary image forming convex lenses 3033A and 3033B. The secondary image forming convex lenses 3031A and 3031B are arranged corresponding to the multi-hole aperture openings 3021A and 3021B. Similarly, the secondary image forming convex lenses 3032A and 3032B are arranged corresponding to the multi-hole aperture openings 3022A and 3022B, and the secondary image forming convex lenses 3033A and 3033B are arranged corresponding to the multi-hole aperture openings 3023A and 3023B.

In the third embodiment, pixels of the focus detecting sensor 400 are arranged as a two-dimensional sensor array, and information about light amount distribution of pixels within a necessary area is extracted and used. Specifically, the focus detecting sensor 400 is provided with three sets of sensor lines including focus detection sensor lines 4001A and 4001B, focus detection sensor lines 4002A and 4002B, and focus detection sensor lines 4003A and 4003B. Each focus detection sensor line extracts signals of pixels within a linear area of which width in the direction that perpendicularly intersects with the correlative direction (hereinafter referred to as a “correlation orthogonal direction”) is 10 pixels and length in the correlation direction is 100 pixels, for example, and outputs signals that are obtained by adding light amounts in the correlation orthogonal direction. Each focus detection sensor line is arranged in the same direction as the direction (correlative direction) in which a light beam of an object image is divided by the multi-hole aperture stop 302. In order to detect an edge of the visual-field-mask opening 3001 etc., each focus detection sensor line is arranged in the area that is wide in the correlative direction with respect to the aperture image of the field mask 300.

It should be noted that a manufacturing error of the focus detecting sensor 400 may cause a minute angular deviation between the correlative direction defined by the secondary image forming lens 303 and the direction of each focus detection sensor line. In order to correct such an angular deviation, i.e., in order to match the correlative direction defined by the secondary image forming lens 303 with the direction of each focus detection sensor line, a gravity-center moving amount in the correlation orthogonal direction is calculated according to the light amounts obtained from each focus detection sensor line. A coefficient for this calculation is measured and stored in the storage unit 211 during the manufacturing process of the image pickup apparatus.

According to the above-mentioned configuration, the light beam passing through the multi-hole aperture opening 3021A forms an image in the area of the focus detection sensor line 4001A through the secondary image forming convex lens 3031A. Moreover, the light beam passing through the multi-hole aperture opening 3021B forms an image in the area of the focus detection sensor line 4001B through the secondary image forming convex lens 3031B. Similarly, the light beams passing through the multi-hole aperture openings 3022A and 3022B form images in the areas of the focus detection sensor lines 4002A and 4002B through the secondary image forming convex lenses 3032A and 3032B. Moreover, the light beams passing through the openings 3023A and 3023B form images in the areas of the focus detection sensor lines 4003A and 4003B through the secondary image forming convex lenses 3033A and 3033B. The focus detecting device 207 calculates a defocus value using the electrical signals that the focus detection sensor lines detect with the focus detection method by well-known secondary image formation phase-difference detection.

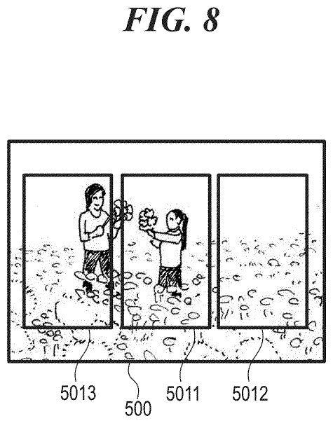

FIG. 8 is a view for describing an image-pickup area 500 of the image pickup apparatus and focus detection areas 5011, 5012, and 5013 arranged in the image-pickup area 500. The focus detection areas 5011, 5012, and 5013 are target areas of the focus detection in the image-pickup area 500 and are defined by the visual-field-mask openings 3001, 3002, and 3003. Optical images in the focus detection areas 5011, 5012, and 5013 are formed on the focus detecting sensor 400. Since the image forming situation of the object images in the focus detection areas 5011, 5012, and 5013 and the situation of the deviation of the image forming positions due to the change in state of the focus detection optical system in the focus detecting device 207 are equivalent to the situations in the first embodiment described by referring to FIG. 3B, FIG. 3C, FIG. 4A, and FIG. 4B, the descriptions thereof are omitted.

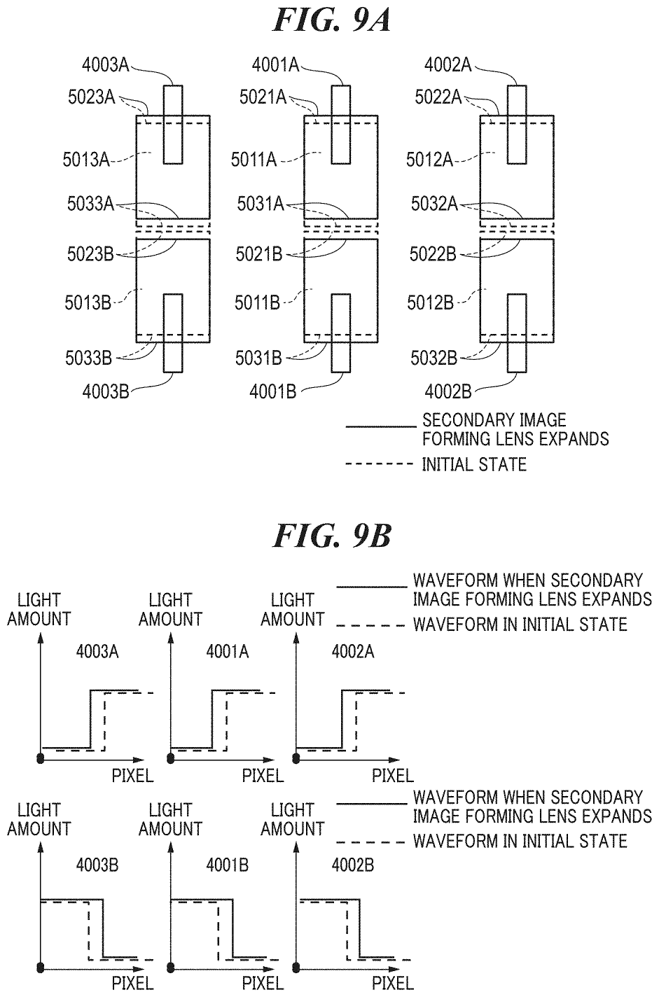

Next, the change in state of the focus detection optical system in the focus detecting device 207 will be described. FIG. 9A is a view for describing optical images formed on the focus detecting sensor 400 in a state where the secondary image forming lens 303 in the focus detecting device 207 expands in comparison to optical images in an initial state. FIG. 9B is a view showing output signals (waveforms) from the focus detection sensor lines in the state where the secondary image forming lens 303 in the focus detecting device 207 expands in comparison to output signals in the initial state.

Since the image areas 5011A and 5011B, the edge images 5021A and 5031A, and the edge images 5021B and 5031B shown in FIG. 9A have been already described by referring to FIG. 4A and FIG. 4B, the descriptions thereof are omitted. It should be noted that the positions of the image areas 5011A and 5011B in the initial state are indicated by broken lines in FIG. 9A.

The image of the focus detection area 5012 is projected as two images on the focus detecting sensor 400 through the multi-hole aperture openings 3022A and 3022B and the secondary image forming convex lenses 3032A and 3032B. It should be noted that positions of image areas 5012A and 5012B in the initial state are indicated by broken lines in FIG. 9 A. Edge images 5022A and 5032A correspond to edges of one optical image formed on the focus detecting sensor 400 by the light beam passing through the visual-field-mask opening 3002. Edge images 5022B and 5032B correspond to edges of the other optical image formed on the focus detecting sensor 400 by the light beam passing through the visual-field-mask opening 3002. The edge images 5022A and 5022B correspond to edges of the images of the opening edge of the same part of the visual-field-mask opening 3002 that are divided by the multi-hole aperture stop 302. The edge images 5032A and 5032B correspond to edges of the images of the opening edge of the other same part of the visual-field-mask opening 3002 that are divided by the multi-hole aperture stop 302.

Similarly, the image of the focus detection area 5013 is projected as two images on the focus detecting sensor 400 through the multi-hole aperture openings 3023A and 3023B and the secondary image forming convex lenses 3033A and 3033B. It should be noted that positions of image areas 5013A and 5013B in the initial state are indicated by broken lines in FIG. 9A. Edge images 5023A and 5033A correspond to edges of one optical image formed on the focus detecting sensor 400 by the light beam passing through the visual-field-mask opening 3003. Edge images 5023B and 5033B correspond to edges of the other optical image formed on the focus detecting sensor 400 by the light beam passing through the visual-field-mask opening 3003. The edge images 5023A and 5023B correspond to edges of the images of the opening edge of the same part of the visual-field-mask opening 3003 that are divided by the multi-hole aperture stop 302. The edge images 5033A and 5033B correspond to edges of the images of the opening edge of the other same part of the visual-field-mask opening 3003 that are divided by the multi-hole aperture stop 302.

As indicated by solid lines in FIG. 9A, when the secondary image forming lens 303 expands, the edge image 5021A moves in one direction with respect to the focus detection sensor line 4001A and the edge image 5031B moves in the opposite direction with respect to the focus detection sensor line 4001B. Thereby, the inter-opening-edge-image distance of the visual-field-mask opening 3001 is larger than the inter-opening-edge-image distance in the initial state indicated by the broken lines. It should be noted that the initial state means the state where the secondary image forming lens 303 does not expand at the time of the focus adjustment of the focus detecting device 207 during manufacture of the image pickup apparatus body 200.

Since the expansion of the secondary image forming lens 303 is linear expansion due to moisture absorption in general, the secondary image forming lens 303 expands as a whole uniformly. Accordingly, the amount of change of each of the inter-opening-edge-image distance of the visual-field-mask openings 3001, 3002, and 3003 is approximately proportional to the vertex position distance of two convex lenses of the secondary image forming lens 303. The distance between the secondary image forming convex lenses 3031A and 3031B, the distance between the secondary image forming convex lenses 3032A and 3032B, and the distance between the secondary image forming convex lenses 3033A and 3033B are approximately equal to each other. Accordingly, the amounts of position changes of the edge images 5021A, 5021B, 5022A, 5022B, 5023A, and 5023B of the visual-field-mask openings 3001, 3002, and 3003 are approximately equal to each other.

The edge images 5021A and 5031A move by the same amount in the same direction. The edge images 5021B and 5031B moves by the same amount in the same direction. However, the edge images 5021A and 5021B move by the same amount in the opposite directions. Accordingly, the amount of change of the inter-opening-edge-image distance 5021D between the edge images 5021A and 5021B (see FIG. 4A) becomes double of the amount of position change of the edge image 5021A. Similarly, the amount of change of the inter-opening-edge-image distance between the edge images 5022A and 5022B becomes double of the amount of position change of the edge image 5022A. Accordingly, the amount of change of the inter-opening-edge-image distance between the edge images 5023A and 5023B becomes double of the amount of position change of the edge image 5023A.

In the state shown in FIG. 9A, the edge image 5021A has been moved from the initial position, and the inter-opening-edge-image distance 5021D has varied by the twice of its moving amount. At this time, since the image areas 5011A and 5011B are close to each other, the distance between the edge images 5021A and 5021B may not be directly calculated. As compared with this, the amount of change of the inter-opening-edge-image distance is found with sufficient accuracy by doubling the calculated amount of change of the edge image 5021A from the initial state.

It should be noted that the positions of the edge images of the visual-field-mask openings 3001, 3002, and 3003 also change when the focus detecting sensor 400 expands and when the distance between the secondary image forming lens 303 and the focus detecting sensor 400 increases as well as the case where the secondary image forming lens 303 expands. Moreover, when the secondary image forming lens 303 contracts, the positions of the edge images change in the directions opposite to the case where the secondary image forming lens 303 expands.

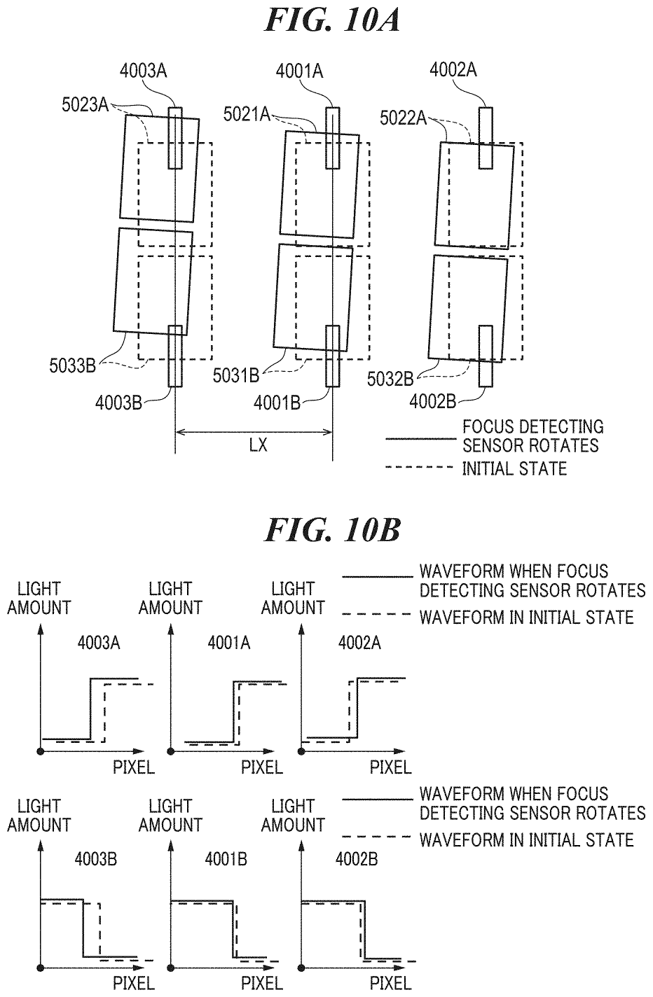

FIG. 10A is a view for describing optical images formed on the focus detecting sensor 400 in a state where the focus detecting sensor 400 in the focus detecting device 207 rotates with respect to the secondary image forming lens 303 in comparison to the optical images in the initial state. FIG. 10B is a view showing output signals (waveforms) from the focus detection sensor lines in the state where the focus detecting sensor 400 in the focus detecting device 207 rotates with respect to the secondary image forming lens 303 in comparison to the output signals in the initial state.

The initial state indicated by broken lines in FIG. 10A is the same as the initial state indicated by the broken lines in FIG. 9A. It is considered that the rotation of the focus detecting sensor 400 respectively moves the edge images 5021A and 5031B with respect to the focus detection sensor lines 4001A and 4001B by the same amount in the same direction. This is because the rotation angle of the focus detecting sensor 400 in FIG. 10A is exaggerated and a possible rotation angle of the focus detecting sensor 400 is considered as 1 degree or less. Accordingly, it is considered that the distance between the edge images, which are indicated by solid lines, of the visual-field-mask opening 3001 in the state where the focus detecting sensor 400 rotates is approximately equal to the distance between the edge images, which are indicated by the broken lines, of the visual-field-mask opening 3001 in the initial state.

Since the focus detecting sensor 400 is a rigid body as a whole, the Edge images 5021A, 5022A, and 5023A rotate by an approximately identical angle. Accordingly, the difference between the positions of the edge images 5021A and 5022A after the change is approximately equal to the difference between the positions of the edge images 5021A and 5023A after the change. Accordingly, the position changes of the edge images 5022A, 5021A, and 5023A relatively change approximately linearly.

At this time, although the position of the edge image 5021A when the focus detecting sensor 400 rotates is moved from the position in the initial state, the inter-opening-edge-image distance 5021D does not change. Therefore, the correction of the inter-image distance is unnecessary. In the meantime, a distance measurement error occurs because the focus detection sensor lines are arranged at the angle deviated from the correlative direction. For example, when the distance between the focus detection sensor lines 4001A and 4003A shall be “LX”, a rotation amount φ that is an amount of change of the angle from the initial state is fund by dividing the difference between the edge images 5023A and 5021A by “LX”. It should be noted that the value of “LX” shall be stored in the storage unit 211 as a design fixed value.

The position changes of the edge images of the visual-field-mask openings 3001, 3002, and 3003 from the initial state are detected, and an in-focus position with respect to an object is corrected by switching a correction content for detecting the focusing state to the object on the basis of the relative position changes of the edge images. The correction content is switched according to whether the position changes of the image edges are the movement shown in FIG. 9A or the rotation shown in FIG. 10A. The position changes of the image edges of the visual-field-mask openings 3001, 3002, and 3003 are detectable using the output signals (waveforms) from the focus detecting sensor 400 corresponding to the light amount distributions of the edge images shown in FIG. 9B and FIG. 10B. The waveforms shown in FIG. 9B and FIG. 10B indicated by the broken lines are obtained using a predetermined uniform luminance surface as an object at the time of the factory shipment of the image pickup apparatus body 200, and are stored in the storage unit 211. The camera CPU 210 detects the position changes of the edge images of the visual-field-mask openings 3001, 3002, and 3003 from the positions in the initial state by performing the correlation operation using the waveforms stored in the storage unit 211 and the output signals from the corresponding focus detection sensor lines.

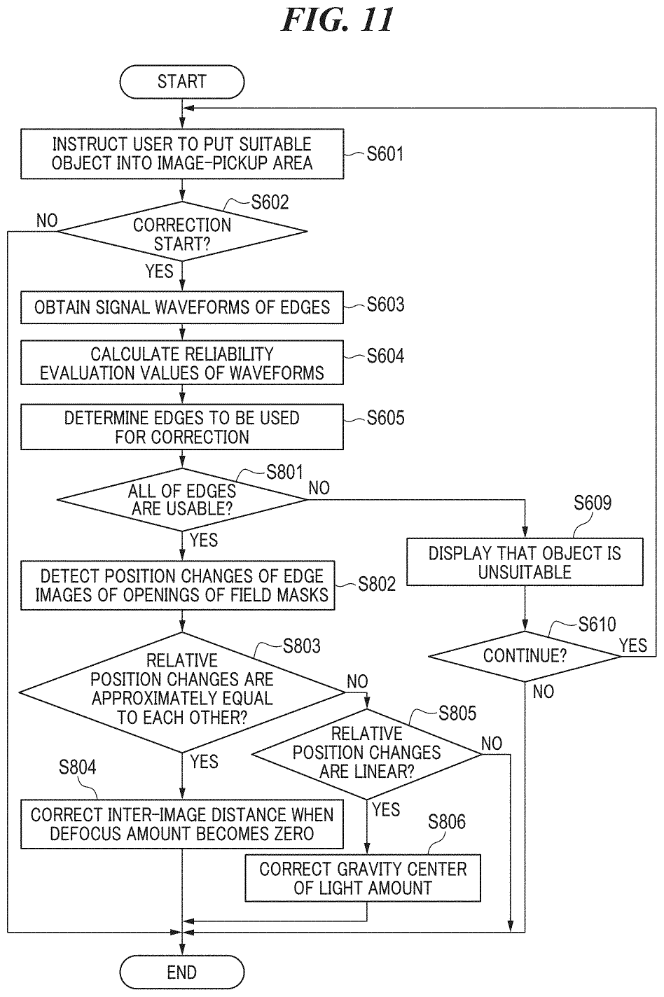

FIG. 11 is a flowchart showing a process for switching the correction content used when the focusing state is detected on the basis of the changes of the edge image positions from the positions in the initial state. Each process (step) shown by S-number in FIG. 11 is achieved when the camera CPU 210 runs a predetermined program stored in the storage unit 211 so as to control actions of each section of the image pickup apparatus body 200. It should be noted that a process (step) in the flowchart in FIG. 11 that is the same as that in the flowchart in FIG. 5 is indicated by the same S-number and that a duplicated description is omitted.

This process shall be started at a timing when a user instructs to execute the process for switching the correction content from a menu screen displayed on the display device 212 of the image pickup apparatus body 200. Since processes in S601 through S605 are equivalent to that in S601 through S605 in FIG. 5, their descriptions are omitted. However, the signal waveforms of the edge images 5021A, 5022A, and 5023A corresponding to the three visual-field-mask openings 3001, 3002, and 3003 are obtained in S603. Accordingly, the reliability evaluation in S604 and the decision of used edge in S605 are performed for each of the signal waveforms of the edge images 5021A, 5022A, and 5023A.

In S801, the camera CPU 210 determines whether all the edge images are usable. When determining that at least one edge is not usable for the correction (NO in S801), the camera CPU 210 proceeds with the process to 5609. Since processes in S601 and S610 are identical to that in S601 and S610 in FIG. 5, their descriptions are omitted. In the meantime, when determining that all the edge images are usable (YES in S801), the camera CPU 210 proceeds with the process to S802.

In S802, the camera CPU 210 detects a position change of an edge image from a position in the initial state for each of the visual-field-mask openings 3001, 3002, and 3003. Specifically, the camera CPU 210 performs the correlation operation between the obtained light amount distribution waveform (output signal) and the light amount distribution waveform in the initial state stored in the storage unit 211 for each of the edge images 5021A, 5022A, and 5023A.

In S803, the camera CPU 210 determines whether the relative position changes of the edge images 5021A, 5022A, and 5023A are approximately equal to each other. That is, it is determined whether the relative position changes of the edge images 5021A, 5022A, and 5023A are equivalent to the position changes shown in FIG. 9A. When the relative position changes of the edge images 5021A, 5022A, and 5023A are 5 micrometers or less, it shall be determined that these position changes are approximately equal to each other. When determining that the relative position changes of the edge images are approximately equal to each other (YES in S803), the camera CPU 210 proceeds with the process to S804. When determining that the relative position changes of the edge images are not approximately equal to each other (NO in S803), the camera CPU 210 proceeds with the process to S805.

In S804, the camera CPU 210 finds the amount of change of the inter-opening-edge-image distance in the state where the defocus amount becomes zero (0), switches the correction content so as to correct an in-focus position using the found amount of change, and then, finishes this process. That is, double of the amount of position change is stored into the storage unit 211 as a correction value for each of the edge images 5021A, 5022A, and 5023A, and finishes this process. Thereafter, the accurate focusing becomes effective (the in-focus state is achieved with a high accuracy) by correcting a focus detection result so as to cancel the position changes of the object images using the correction value stored in the storage unit 211. Although the correction value is calculated only using the position moving amounts of the edge images 5021A, 5022A, and 5023A by comparing the positions of these edge images in this embodiment, the correction value may be calculated by further considering the position moving amounts of the edge images 5031B, 5032B, and 5033B. In such a case, the correction value in which dispersion is further reduced is calculated.

In S805, the camera CPU 210 determines whether the relative position changes of the edge images 5021A, 5022A, and 5023A are approximately linear. That is, it is determined whether the relative position changes of the edge images 5021A, 5022A, and 5023A are equivalent to the position changes shown in FIG. 10A. In the description, when the position changes “L1”, “L2”, and “L3” of the edge images 5021A, 5022A, and 5023A satisfy the following condition, it shall be determined that the relative position changes are approximately linear.

[(L3−L1)−(L1−L2)]≤5 μm

When determining that the relative position changes of the edge images are approximately linear (YES in S805), the camera CPU 210 proceeds with the process to S806. When determining that the relative position changes of the edge images are not approximately linear (NO in S805), the camera CPU 210 finishes this process.

In S806, the camera CPU 210 performs a process for correcting a gravity center of a light amount. Specifically, the camera CPU 210 calculates the gravity-center moving amount of the light amount described with reference to FIG. 10A, i.e., calculates the rotation amount φ of the focus detecting sensor 400 with respect to the secondary image forming lens 303. The rotation amount φ is calculated by (L3−L1)/LX (see FIG. 10A), as mentioned above. The camera CPU 210 stores the calculated rotation amount φ into the storage unit 211 as a correction value. In actual image pick-up, an in-focus position is corrected by moving a gravity center of a light amount using the rotation amount φ (correction amount) stored to the storage unit 211. When the process in S806 is terminated, this process is finished. Moreover, when the determination result in S805 is NO, the correction content is not changed.

As described above, the correction content used for detecting the focusing state is switched according to the relative position changes of the edge images of the visual-field-mask openings in the third embodiment. Accordingly, even if the inter-edge-image distance when the defocus amount becomes zero changes due to expansion or contraction of the secondary image forming lens 303, the change is corrected with the sufficient accuracy. Moreover, even if the focus detecting sensor 400 rotates with respect to the secondary image forming lens 303 and a gravity center of a light amount moves, the change is corrected with the sufficient accuracy. At this time, when signal waveforms about edges are obtained and averaged, a correlation operation error due to noise components in the waveforms is reduced and a correlation calculation result calculated using more suitable waveforms of which contrasts are small is usable. This enables to calculate a more highly accurate correction value.

Next, a fourth embodiment of the present invention will be described. The fourth embodiment describes a configuration that obtains output waveforms about edge images of the visual-field-mask opening provided in the field mask and that enables to calculate a more highly accurate correction value by employing a correlation operation result calculated using suitable waveforms. Since the schematic structure of the image pickup apparatus according to the fourth embodiment is the same as the image pickup apparatus according to the first embodiment except for the configuration of the focus detecting device, the common description is omitted. In the following description, a component of the focus detecting device in the fourth embodiment that has a function equivalent to a component of the focus detecting device 207 shown in FIG. 2 is indicated by the same reference numeral and a duplicated description is omitted. Moreover, the camera CPU 210 controls the sections according to the configuration of the focus detecting device.

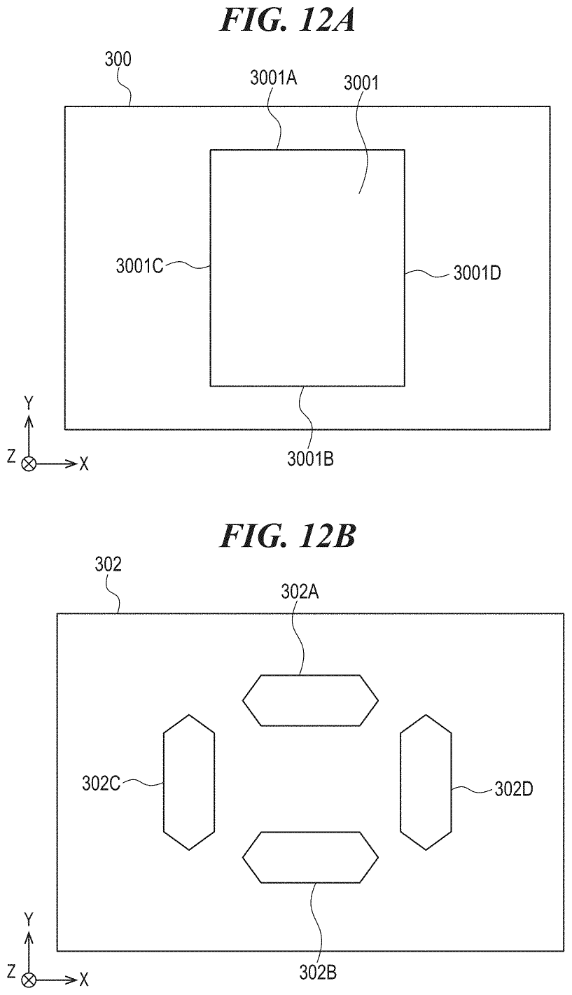

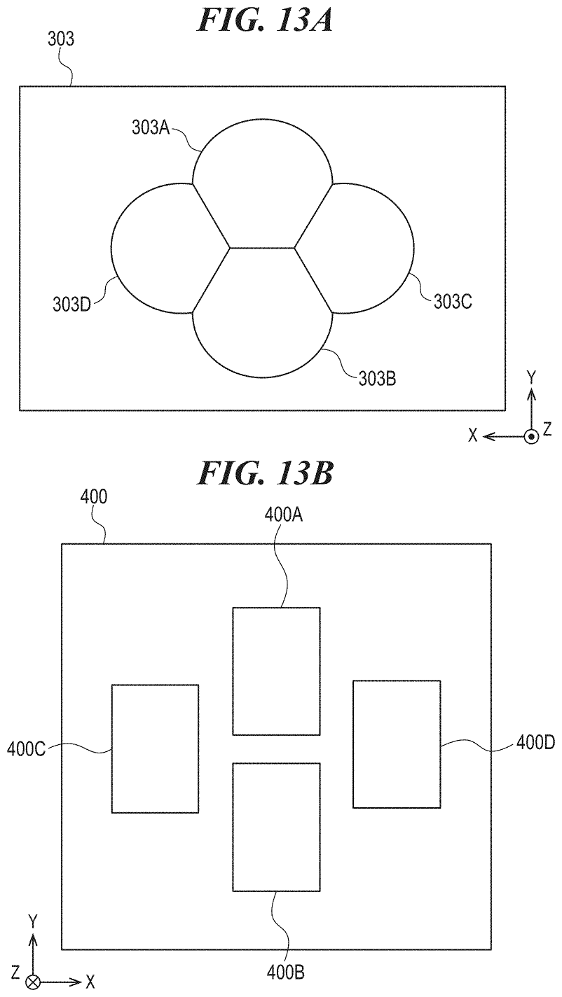

FIG. 12A is a plan view of a field mask 300. FIG. 12B is a plan view of a multi-hole aperture stop 302. FIG. 13A is a plan view of a secondary image forming lens 303 viewed from a side of a focus detecting sensor 400 side. FIG. 13B is a plan view of the focus detecting sensor 400 viewed from the side of the secondary image forming lens 303. An X-axis, a Y-axis, and a Z-axis that mutually intersect perpendicularly are defined in FIG. 12A, FIG. 12B, FIG. 13A, and FIG. 13B for convenience of description. In the description, the correlative directions in which the light beam of the object image is divided are a vertical direction (a Y-axis direction) and a horizontal direction (an X-axis direction) on the sheet in FIG. 12A, FIG. 12B, FIG. 13A, and FIG. 13B.

A visual-field-mask opening 3001 that defines an image field imaged on the focus detecting sensor 400 is provided in the center of the field mask 300. The visual-field-mask opening 3001 has four opening edges 3001a, 3001b, 3001c, and 3001d, and the focus detecting sensor 400 detects these opening edges as mention later. The multi-hole aperture stop 302 has openings 302A, 302B, 302C, and 302D that are provided in four places. The openings 302A through 302D divide the light beam of an object image that enters from the field lens 301. The openings 302A and 302B divide the object image in the vertical direction (Y-axis direction), and the openings 302C and 302D divide the object image in the horizontal direction (X-axis direction).

The secondary image forming lens 303 is a sheet-like component that is provided with four secondary image forming convex lenses 303A, 303B, 303C, and 303D in the surface opposite to the focus detecting sensor 400. The secondary image forming convex lenses 303A through 303D are arranged corresponding to the openings 302A through 302D of the multi-hole aperture stop 302. The secondary image forming convex lenses 303A through 303D re-form the object image formed on the primary image plane with the photographing lens 100 on the focus detecting sensor 400. The light beam passing through the opening 302A of the multi-hole aperture stop 302 forms an image with the secondary image forming convex lens 303A. Similarly, the light beams passing through the openings 302B, 302C, and 302D form images on the focus detecting sensor 400 with the corresponding secondary image forming convex lenses 303B, 303C, and 303D.

Although the focus detecting sensor 400 is what is called a line sensor in this embodiment, a pixel arrangement is not limited to the linear arrangement. For example, the sensor 400 may be an area sensor that combines the same sensor arrays. The object images of the visual-field-mask opening 3001 are formed on sensor areas 400A, 400B, 400C, and 400D provided in the focus detecting sensor 400. For example, the light beam passing through the opening 302A of the multi-hole aperture stop 302 forms an image in the sensor area 400A with the secondary image forming convex lens 303A. Similarly, the light beams passing through the openings 302B, 302C, and 302D of the multi-hole aperture stop 302 respectively form images in the sensor areas 400B, 400C, and 400D with the secondary image forming convex lenses 303B, 303C, and 303D.

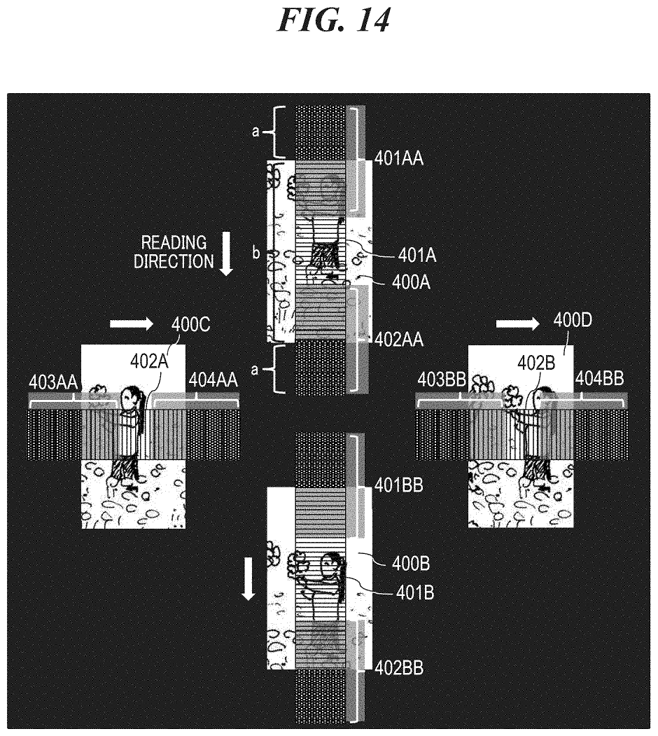

FIG. 14 is a view for describing the object images formed on the focus detecting sensor 400. The object images are formed in the sensor areas 400A and 400B divided in the vertical direction and the sensor areas 400C and 400D divided in the horizontal direction. The images of the opening edges 3001a through 3001d of the field mask 300 (opening edge images) are detected with a set of the focus detection sensor lines 401A and 401B and a set of the focus detection sensor lines 402A and 402B of the focus detecting sensor 400. When the number of the focus detection sensor lines that detect the opening edge image increases, probability of outputting suitable waveforms becomes higher, which enables to calculate a more highly accurate correction value.

Areas “a” shown in FIG. 14 are excluded from the focus detection area of the focus detection sensor line 401A. An area “b” shown in FIG. 14 is included in the focus detection area of the focus detection sensor line 401A. Each of the other focus detection sensor lines 401B, 402A, and 402B is also divided into the areas “a” and “b” (not shown) as with the focus detection sensor line 401A. A reading start position and a reading end position in each focus detection sensor line are freely set up within each focus detection sensor line. For example, a reading start position and a reading end position of each of reading areas 401AA and 402AA of the focus detection sensor line 401A are set across the boundary of the inside and outside of the focus detection area. Reading areas 401BB, 402BB, 403AA, 404AA, 403BB, and 404BB of the other focus detection sensor lines 401B, 402A, and 402B are set up in the same manner as the reading areas 401AA and 402AA of the focus detection sensor line 401A.

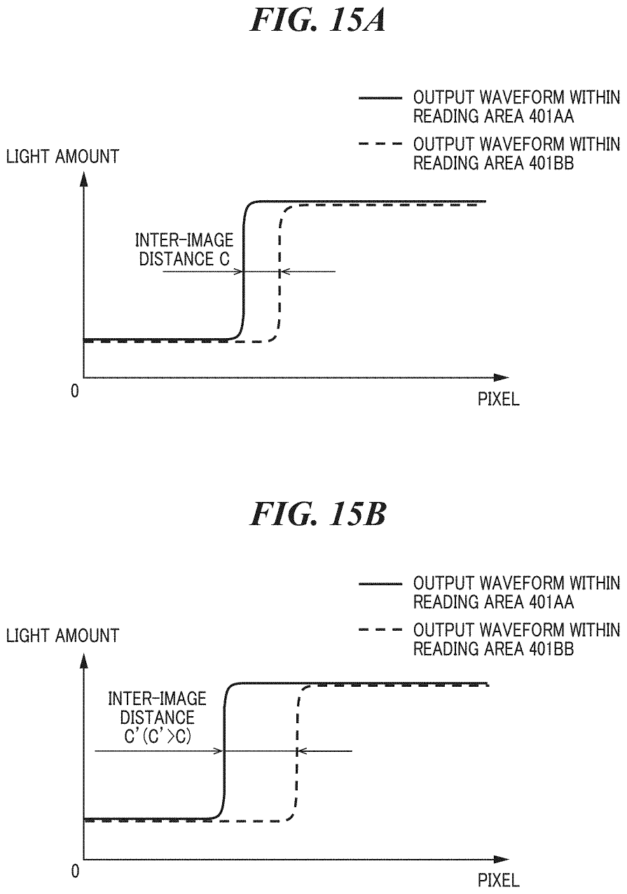

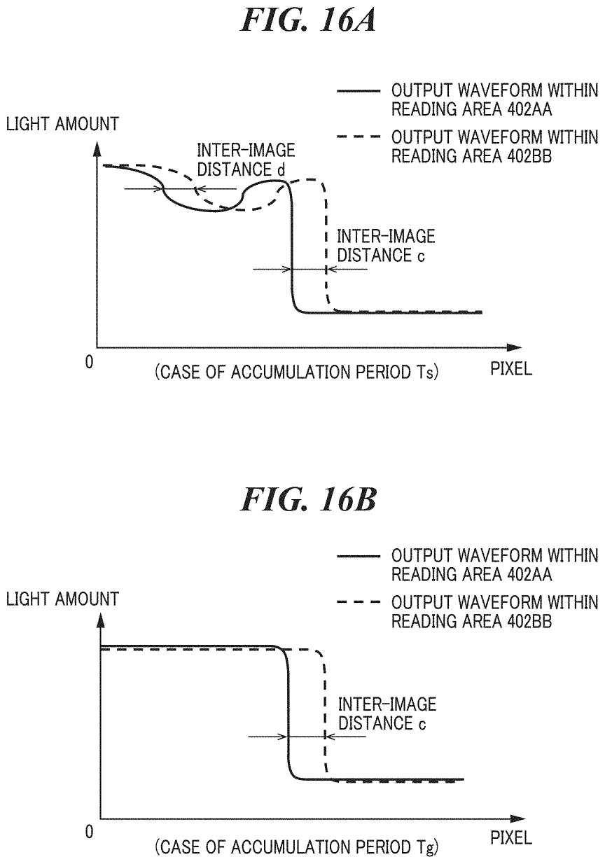

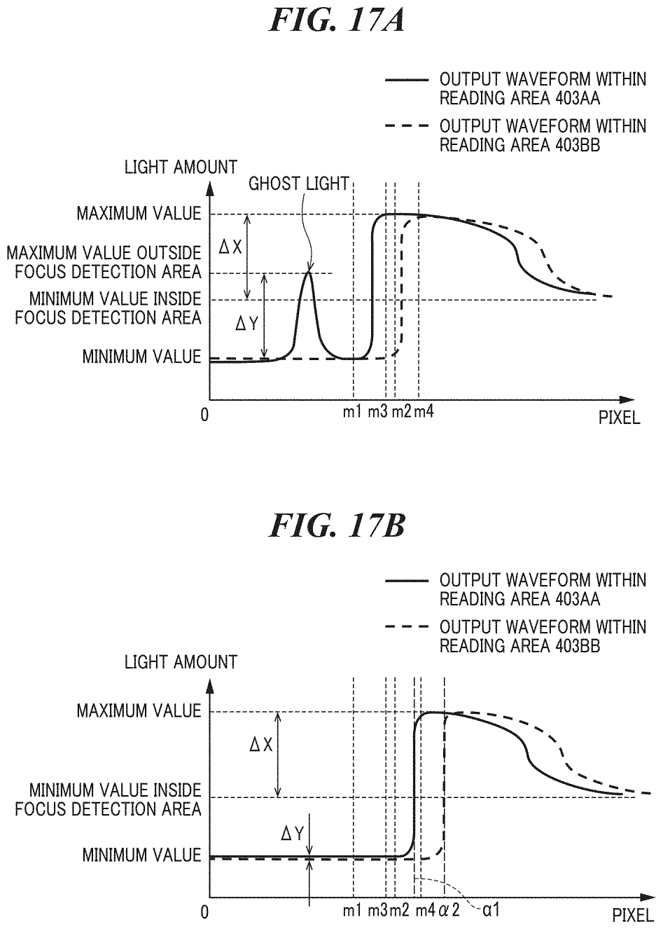

FIG. 15A and FIG. 15B are views showing output waveforms from the focus detecting sensor 400 when the state of the focus detection optical system is changed. In FIG. 15A and FIG. 15B, a vertical axis shows an amount of light that reaches a predetermined focus detection sensor line, a horizontal axis shows a pixel column of the focus detecting sensor. These definitions are identical also in FIG. 16A, FIG. 16B, FIG. 17A, and FIG. 17B mentioned later.

FIG. 15A shows output waveforms in the reading areas 401AA and 401BB in the ideal state where the focus detection optical system does not change from the state at the time of adjustment at the factory. An inter-image distance C shown in FIG. 15A is beforehand stored in the storage unit 211 at the factory etc. In the meantime, it has been already described that a projection position of an object image on the focus detecting sensor 400 changes resulting from various changes in state of the focus detection optical system. FIG. 15B shows output waveforms in the reading areas 401AA and 401BB in a state where the state of the focus detection optical system changes from the state at the time of adjustment at the factory. This example shows a case where the secondary image forming lens 303 expands due to moisture absorption. When the secondary image forming lens 303 expands, the projection positions of the opening edge images on the focus detecting sensor 400 change and an inter-image distance C′ becomes larger than the inter-image distance C (C′>C). Since the calculation method of the defocus amount in the case where the inter-image distance changes has been described in the first embodiment, the description is omitted.

FIG. 16A and FIG. 16B are views showing output waveforms from the focus detecting sensor 400 in two different accumulation periods. The output waveforms in the reading areas 402AA and 402BB in a case of the accumulation period Ts are shown in FIG. 16A in superposition. The output waveforms in the reading areas 402AA and 402BB in a case of the accumulation period Tg that is longer than Ts (Tg>Ts) are shown in FIG. 16B in superposition.

FIG. 16A shows that the defocus amount may be calculated on the basis of the inter-image distance “d” even when the defocus amount should be calculated on the basis of the inter-image distance “c” when the accumulation period is short. As compared with this, FIG. 16B shows that it becomes easy to calculate the defocus amount on the basis of the inter-image distance “c” when contrast of an object image is reduced by extending the accumulation period. However, since the photographing time depends on the accumulation period, the accumulation period should be shortened within a range where the probability that the defocus amount is calculated on the basis of the inter-image distance “c” is high.

FIG. 17A and FIG. 17B are views showing examples of output waveforms in the reading areas 403AA and 403BB of the focus detecting sensor 400 in a case where an object (a photographing condition) is unsuitable for detecting the inter-image distance. A range from a position ml to a position m2 is an assumed range in design within which the opening edge image is projected in the reading area 403AA. And the range is decided in consideration of a movement of the projection position of the opening edge image due to change of state of the focus detection optical system. Similarly, a range from a position m3 to a position m4 is an assumed range in design within which the opening edge image is projected in the reading area 403BB.

An evaluation value for determining whether an object with high contrast is in the focus detection area shall be a reliability evaluation value ΔX. Accordingly, the reliability evaluation value ΔX indicates contrast in the focus detection area. The reliability evaluation value ΔX is calculated by the following method. That is, a difference “A” between the maximum value in the reading area 403AA and the minimum value in the focus detection area. Moreover, a difference “B” between the maximum value in the reading area 403BB and the minimum value in the focus detection area. The larger one among the differences A and B is set to the reliability evaluation value ΔX.

As compared with this, an evaluation value for determining whether ghost light that is unnecessary light reaches the reading area outside the focus detection area shall be a reliability evaluation value ΔY. Accordingly, the reliability evaluation value ΔY indicates contrast outside the focus detection area. The reliability evaluation value ΔY is calculated by the following method. That is, a difference “C” between the minimum value in the reading area 403AA and the maximum value outside the focus detection area. Similarly, a difference “D” between the minimum value in the reading area 403BB and the maximum value outside the focus detection area. The larger one among the differences C and D is set to the reliability evaluation value ΔY.

FIG. 17A shows the output waveforms when ghost light that is unnecessary light reaches outside the focus detection area of the reading area 403AA. In this case, the reliability evaluation value ΔY becomes large, which means low reliability. Accordingly, as mentioned later, when the reliability evaluation value ΔY is equal to or more than a predetermined threshold, the photographing condition is determined to be unsuitable for calculating the correction value.

FIG. 17B shows the output waveforms when a black object is located near the opening edges 3001a through 3001d in the focus detection area. In FIG. 17B, a waveform rising position α1 in the reading area 403AA is outside the range from the position m1 to the position m2. Moreover, a waveform rising position α2 in the reading area 403BB is outside the range from the position m3 to the position m4. The waveform rising positions α1 and α2 are indices for determining whether the inter-opening-edge-image distance of the field mask 300 is detected appropriately. That is, when the waveform rising positions α1 and α2 are respectively positioned outside the ranges as mentioned above, the inter-object-image distance of the object is calculated on the basis of the output signals from the reading areas instead of calculating the inter-opening-edge-image distance. As described in the first embodiment, the inter-object-image distance, which is not the inter-opening-edge-image distance of the field mask 300, is not suitable for calculating the correction value.

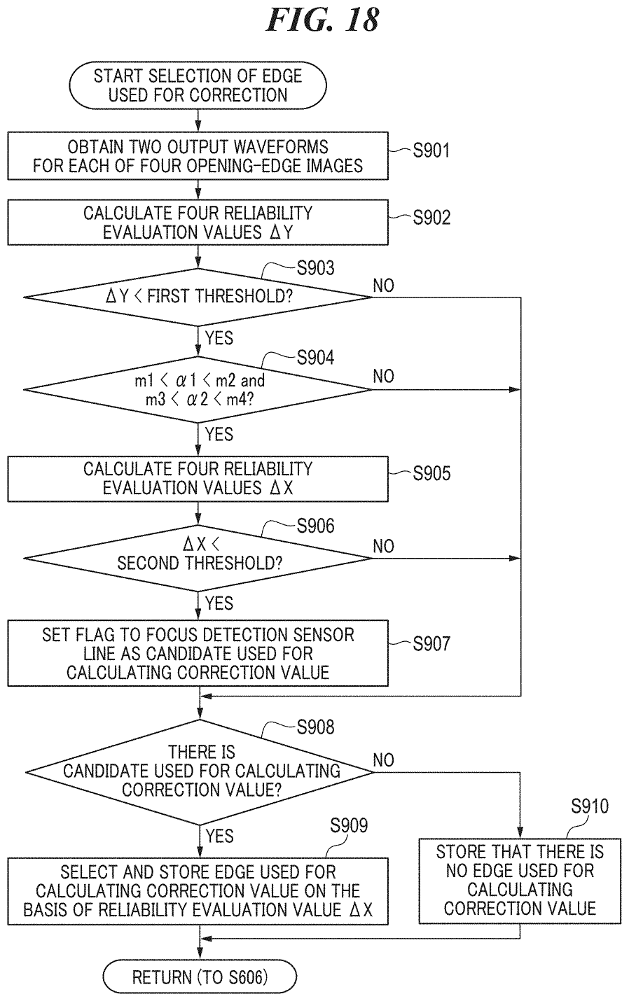

FIG. 18 is a flowchart showing a process for selecting an edge image used for calculating a correction value in the fourth embodiment. The reliability evaluation values ΔX and ΔY are calculated for each of the four opening edges 3001a through 3001d, and the edge image (opening edge) that is used for calculating the correction value is selected on the basis of the calculated reliability evaluation values ΔX and ΔY. Each process (step) shown by S-number in FIG. 18 is achieved when the camera CPU 210 runs a predetermined program stored in the storage unit 211 so as to control actions of each section of the image pickup apparatus body 200.

It should be noted that the processes in S901 through S910 shown in FIG. 18 correspond to a detail description of the contents of processes in S603 through S605 in the flowchart in FIG. 5. Accordingly, when the correction value is calculated, the processes in S601 and S602 and the processes in S606 through S610 in the flowchart in FIG. 5 are performed before and after the process in FIG. 18. However, the descriptions about S601 through S610 are omitted here.

In S901 after S602, the camera CPU 210 obtains four pairs of output waveforms about the four opening edges 3001a through 3001d from the reading areas of the four focus detection sensor lines 401A, 401B, 402A and 402B (see FIG. 14). In S902, the camera CPU 210 calculates the four reliability evaluation values ΔY according to the output waveforms obtained in S901. In S903, the camera CPU 210 determines whether at least one of the reliability evaluation values ΔY is less than a predetermined first threshold. The first threshold is defined beforehand and stored in the storage unit 211. When determining that at least one of the reliability evaluation values ΔY is less than the first threshold (YES in S903), the camera CPU 210 proceeds with the process to S904. When determining that all the reliability evaluation values ΔY are equal to or more than the first thresholds (NO in S903), the camera CPU 210 proceeds with the process to S908. For example, FIG. 17A shows the case where the reliability evaluation value ΔY is equal to or more than the first threshold.

In S904, the camera CPU 210 determines whether the waveform rising positions α1 and α2 of at least one pair of the output waveforms respectively fall within the range from the position m1 to the position m2 and the range from the position m3 to the position m4. When determining that at least one pair of the output waveforms satisfy these conditions (m1<α1<m2 and m3<α2<m4) (YES in S904), the camera CPU 210 proceeds with the process to S905. When determining that all the pairs of the output waveforms do not satisfy these conditions (NO in S904), the camera CPU 210 proceeds with the process to S908. It should be noted that the ranges that prescribe the waveform rising positions α1 and α2 are beforehand stored in the storage unit 211 at the time of adjustment at the factory. Moreover, FIG. 17B shows an example of a case where the conditions of m1<α1<m2 and m3<α2<m4 are not satisfied.

In S905, the camera CPU 210 calculates four reliability evaluation values ΔX from the output waveforms obtained in S901. In S906, the camera CPU 210 determines whether at least one of the reliability evaluation values ΔX is less than a second threshold. The second threshold is defined beforehand and stored in the storage unit 211. When determining that at least one of the reliability evaluation values ΔX is less than the second threshold (YES in S906), the camera CPU 210 proceeds with the process to S907. When determining that all the reliability evaluation values ΔX are equal to or more than the second threshold (NO in S906), the camera CPU 210 proceeds with the process to S908. For example, when an object with large contrast is in the focus detection area of the reading areas 403AA and 403BB, the reliability evaluation value ΔX becomes more than the second threshold.

In S907, the camera CPU 210 sets a flag to a reading area of a focus detection sensor line as a candidate used for calculating the correction value. In S908, the camera CPU 210 determines whether there is a reading area to which a flag is set. When determining that there is a reading area to which a flag is set (YES in S908), the camera CPU 210 proceeds with the process to S909. When determining that there is no reading area to which a flag is set (NO in S908), the camera CPU 210 proceeds with the process to S910.

In S909, the camera CPU 210 selects an edge image used for calculating the correction value on the basis of the reliability evaluation value ΔX and stores it to the storage unit 211. Specifically, the camera CPU 210 selects the edge image with the smallest reliability evaluation value ΔX. In the meantime, in S910, the camera CPU 210 stores that there is no edge image used for calculating the correction value into the storage unit 211. This process is finished by S909 and S910, and the process is proceeded to S606.

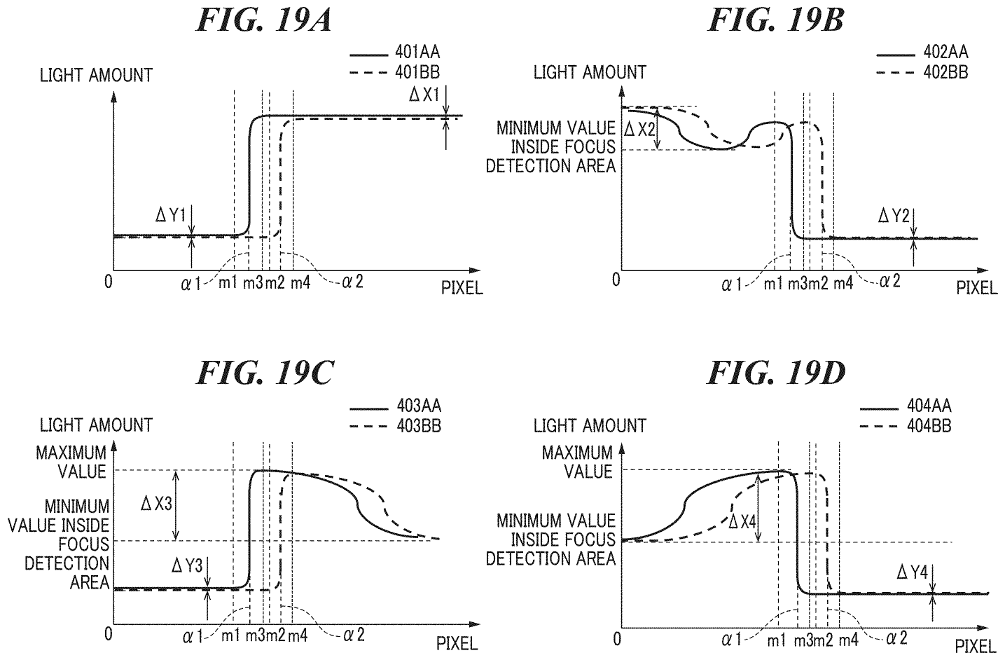

FIG. 19A, FIG. 19B, FIG. 19C, and FIG. 19D are views showing examples of output waveforms from respective reading areas. FIG. 19A shows the output waveforms from the reading areas 401AA and 401BB. Reliability evaluation values ΔX1 and ΔY1 are found from these output waveforms. FIG. 19B shows the output waveforms from the reading areas 402AA and 402BB. Reliability evaluation values ΔX2 and ΔY2 are found from these output waveforms. FIG. 19C shows the output waveforms from the reading areas 403AA and 403BB. Reliability evaluation values ΔX3 and ΔY3 are found from these output waveforms. FIG. 19D shows the output waveforms from the reading areas 404AA and 404BB. Reliability evaluation values ΔX4 and ΔY4 are found from these output waveforms.

It should be noted that a range from a position m1 to a position m2 is an assumed range in design within which the opening edge image is projected in each of the reading areas 401AA, 402AA, 403AA, and 404AA. Moreover, a range from a position m3 to a position m4 is an assumed range in design within which the opening edge image is projected in each of the reading areas 401BB, 402BB, 403BB, and 404BB.

The reading areas 401AA and 401BB in FIG. 19A detect the edge images that the camera CPU 210 determines to use for calculating the correction value. That is, the reading areas 401AA and 401BB are subjected to flag setting. The other reading areas in FIG. 19B, FIG. 19C, and FIG. 19D do not detect suitable edge images. Hereinafter, the reason will be described.

Ghost light does not reach the reading areas shown in FIG. 19A through FIG. 19D. Accordingly, all the reliability evaluation values ΔY1, ΔY2, ΔY3, and ΔY4 are determined to be smaller than the first threshold. As a result, the reliability evaluation value ΔY cannot be used to select reading areas used for calculating the correction value.

Next, selection of reading areas used for calculating the correction value by the waveform rising positions α1 and α2 is tried. Since the conditions of m1<α1<m2 and m3<α2<m4 are satisfied in all of FIG. 19A through FIG. 19D, the reading areas used for calculating the correction value cannot be selected by the waveform rising positions α1 and α2.

Next, selection of reading areas used for calculating the correction value by the reliability evaluation values ΔX1, ΔX2, ΔX3, and ΔX4 is tried. FIG. 19A through FIG. 19D shows the following relationship between the reliability evaluation values: ΔX1<ΔX2<ΔX3=ΔX4. Since the smallest value indicates the most reliable edge image as mentioned above, the reading areas 401AA and 401BB shown in FIG. 19A are selected as the reading areas used for calculating the correction value.

In the fourth embodiment, the reliability evaluation values are calculated for edges of the visual-field-mask opening, and an edge used for calculating the correction value is selected on the basis of the calculated reliability evaluation values as mentioned above. This enables to avoid selection of a focus detection sensor line to which ghost light is reached, and a mistake enables selection of a focus detection sensor line of which an output waveform from an object image is small in contrast. Moreover, even when a black object is located near the opening edge of the visual-field-mask opening, false recognition of the edge of the black object as the opening edge is avoidable.

Although the present invention has been described in detail on the basis of the suitable embodiments, the present invention is not limited to these specific embodiments and includes various configurations that do not deviate from the gist of this invention. Furthermore, the embodiments mentioned above show examples of the present invention, and it is possible to combine the embodiments suitably. The start instruction for the focus adjustment value correction process in the above-mentioned first, third, and fourth embodiments may be issued using cumulative time of a power ON state, the cumulative number of taken images, environmental temperature, etc. as an index.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-138630, filed Jul. 24, 2018, which is hereby incorporated by reference herein in its entirety.

What is claimed is:

1. An image pickup apparatus comprising:
an optical element that guides an incident light beam from an object; and
a focus detecting unit configured to receive the incident light beam guided by the optical element, the focus detecting unit comprising:
a focus detecting sensor that converts a light amount distribution of an object image into an electrical signal;
an image forming lens that makes the incident light beam form object images on the focus detecting sensor;
a field mask that is arranged between the optical element and the image forming lens and that has an opening for defining an image field of the object images formed on the focus detecting sensor;
a storage unit configured to store an initial value about the opening of the field mask that is comparable with the output signal from the focus detecting sensor; and
a correction unit configured to set up a correction value for detecting a focusing state to an object based on a value about the opening of the field mask calculated from the output signal of the focus detecting sensor at a predetermined timing and the initial value.

2. The image pickup apparatus according to claim 1, further comprising a determination unit configured to find a relative positional relationship between light amount distributions of the object images and to determine the focusing state to the object using the relative positional relationship and the correction value stored in the storage unit.

3. The image pickup apparatus according to claim 1, wherein the incident light beam is divided into a plurality of light beams after passing through a plurality of areas, and wherein each of the value about the opening of the field mask and the initial value indicates relative positional relationship between images of a common edge of the opening of the field mask in the object images that are formed on the focus detecting sensor by the light beams.

4. The image pickup apparatus according to claim 1, wherein the incident light beam is divided into a plurality of light beams after passing through a plurality of areas, and wherein each of the value about the opening of the field mask and the initial value indicates light amount distributions showing images of edges of the opening of the field mask in the object images that are formed on the focus detecting sensor by the light beams.

5. The image pickup apparatus according to claim 1, wherein the correction unit comprises:
a calculation unit configured to calculate reliability evaluation values of edge images of the opening of the field mask;
a selection unit configured to select an edge image used for calculating the correction value based on the reliability evaluation values; and
an operation unit configured to find the correction value based on the output signal of the focus detecting sensor corresponding to the edge image that the selection unit selected.

6. The image pickup apparatus according to claim 5, wherein the reliability evaluation values indicate contrast in a focus detection area of the focus detecting sensor and contrast outside the focus detection area.

7. An image pickup apparatus comprising:
an optical element that guides an incident light beam from an object; and
a focus detecting unit configured to receive the incident light beam guided by the optical element, the focus detecting unit comprising:
a focus detecting sensor that converts a light amount distribution of an object image into an electrical signal;
an image forming lens that makes the incident light beam form object images on the focus detecting sensor;
a field mask that is arranged between the optical element and the image forming lens and that has openings for defining image fields of the object images formed on the focus detecting sensor;
a storage unit configured to store initial values indicating positions of edge images of the openings provided in the field mask that are comparable with the output signal from the focus detecting sensor;
a detection unit configured to detect position changes of the edge images of the openings of the field mask, which are found from the output signal of the focus detecting sensor at a predetermined timing, from the initial values; and
a correction unit configured to switch a method of setting a correction value for correcting a focusing state to an object according to the relative position changes of the edge images that the detection unit detected.

8. The image pickup apparatus according to claim 7, wherein the correction unit sets double of an amount of position change of the edge image from the initial value as the correction value for correcting an in-focus position in a case where the relative position changes of the edge images are approximately equal to each other, and
wherein the correction unit sets a gravity-center moving amount in a correlation orthogonal direction of the light amount obtained from the focus detecting sensor as the correction value for correcting the in-focus position in a case where the relative position changes of the edge images are approximately linear.

9. The image pickup apparatus according to claim 1, further comprising a receiving unit configured to receive an instruction to set the correction value by the correction unit,
wherein the predetermined timing is a timing at which the receiving unit receives the instruction.

10. The image pickup apparatus according to claim 1, wherein the predetermined timing is a timing at which the focusing state to an object is detected for image pickup.

11. A focus detection method for an image pickup apparatus, the focus detection method comprising:
a step of making a light beam that enters through an opening provided in a field mask that defines an image field form object images on a focus detecting sensor;
a step of detecting light amount distributions of the object images as electrical signals by the focus detecting sensor;
a step of calculating a value about an image of the opening of the field mask from the electrical signals;
a step of setting a correction value for detecting an in-focus position to an object by comparing the calculated value with an initial value that is beforehand found as a value about the opening of the field mask; and
a step of correcting the in-focus position to the object using the correction value during photographing.

12. A focus detection method for an image pickup apparatus, the focus detection method comprising:
a step of making light beams that enter through openings provided in a field mask that defines an image field form object images on a focus detecting sensor;
a step of detecting a light amount distribution of each of the object images as an electrical signal by the focus detecting sensor;
a step of calculating a position of an edge image of each of the openings of the field mask from the electrical signal;
a step of setting a correction value for detecting an in-focus position to an object by comparing the calculated position with an initial value that is beforehand found as a value about a position of an edge image of each of the openings of the field mask; and
a step of correcting the in-focus position to the object using the correction value during photographing,
wherein the correction value for correcting the in-focus position is set to double of an amount of position change of the edge image from the initial value in the step of setting the correction value in a case where the relative position changes of the edge images are approximately equal to each other, and
wherein the correction value for correcting the in-focus position is set to a gravity-center moving amount in a correlation orthogonal direction of the light amount obtained from the focus detecting sensor in the step of setting the correction value in a case where the relative position changes of the edge images are approximately linear.

13. A non-transitory computer-readable storage medium storing a focus detection program causing a computer to execute a focus detection method for an image pickup apparatus, the focus detection method comprising:
a step of making a light beam that enters through an opening provided in a field mask that defines an image field form object images on a focus detecting sensor;
a step of detecting light amount distributions of the object images as electrical signals by the focus detecting sensor;
a step of calculating a value about an image of the opening of the field mask from the electrical signals;
a step of setting a correction value for detecting an in-focus position to an object by comparing the calculated value with an initial value that is beforehand found as a value about the opening of the field mask; and
a step of correcting the in-focus position to the object using the correction value during photographing.

14. A non-transitory computer-readable storage medium storing a focus detection program causing a computer to execute a focus detection method for an image pickup apparatus, the focus detection method comprising:
a step of making light beams that enter through openings provided in a field mask that defines an image field form object images on a focus detecting sensor;
a step of detecting a light amount distribution of each of the object images as an electrical signal by the focus detecting sensor;
a step of calculating a position of an edge image of each of the openings of the field mask from the electrical signal;
a step of setting a correction value for detecting an in-focus position to an object by comparing the calculated position with an initial value that is beforehand found as a value about a position of an edge image of each of the openings of the field mask; and
a step of correcting the in-focus position to the object using the correction value during photographing,
wherein the correction value for correcting the in-focus position is set to double of an amount of position change of the edge image from the initial value in the step of setting the correction value in a case where the relative position changes of the edge images are approximately equal to each other, and
wherein the correction value for correcting the in-focus position is set to a gravity-center moving amount in a correlation orthogonal direction of the light amount obtained from the focus detecting sensor in the step of setting the correction value in a case where the relative position changes of the edge images are approximately linear.
